(19) United States
(12) Patent Application Publication
(10) Pub. No.: US 2025/0025772 A1
(43) Pub. Date: Jan. 23, 2025

(54) PERIPHERAL INPUT DEVICE MODULE

(71) Applicant: TANGI0 LIMITED, London (GB)

(72) Inventors: Ming KONG, London (GB); Jose RODRIGUEZ JAVALOYES, Elche (ES); Hamidreza NIKKHOU SARIGHIEH, Harlow (GB); Olivia Alice Sarah COWLING, London (GB); Alasdair Simon MCPHAIL, London (GB); William David ROWLEY, London (GB); Zhe DING, London (GB); Liucheng GUO, London (GB)

(21) Appl. No.: 18/274,111

(22) PCT Filed: Jan. 25, 2022
(86) PCT No.: PCT/GB2022/050190

§ 371 Date: Jul. 25, 2023

(30) Foreign Application Priority Data
Jan. 25, 2021 (GB) 2101000.4

(51) Int. Cl. A63F 13/24; A63F 13/218; G06F 3/044

(52) U.S. Cl. CPC A63F 13/24; A63F 13/218; G06F 3/044

(57) ABSTRACT

A peripheral input device module is connectable to a main control device to provide electrical signal(s) in response to a user interaction. The input device comprises one or more thermo-formable non-metallic conductive sensing electrodes configured to provide electrical signal(s) in response to a change in capacitance between (i) a sensing portion of the respective sensing electrode and a conductive object, and/or (ii) a sensing portion of the respective sensing electrode and a sensing portion of another of the one or more sensing electrodes or another sensing portion of the respective sensing electrode. At least one of the sensing electrodes comprises one or more connector portions that form an electrical connector. Each connector portion is configured to electrically connect to a respective electrical contact of a capacitive sensing circuit of the main control device for measuring the electrical signals.

### TECHNICAL FIELD

This invention relates generally to a peripheral input device module that is connectable to a main control device to form a coherent modular control device and provide one or more electrical signals to the main control device in response to a user interaction with the input device module.

### BACKGROUND TO THE INVENTION

A peripheral input device is an auxiliary device used to provide signals or to transfer data or command functions to a computing device, usually for controlling the computing device. Well known examples include computer peripherals such as a keyboard and mouse, consumer products such as handheld television controllers, and gaming controllers. These peripheral input devices are most commonly in wired or wireless communication with the computing device and provide user functionality to the computing device.

More recently, there is increasing interest in modular control devices that are capable of changing its input configuration to provide a user customisable control interface. Modular control devices comprise a main control device and one or more physically separate control components or peripherals that attach to the main device to form a coherent single physical object or modular control device. Each control component can provide a different user input functionality to the main device to change how the user interacts with the resulting control device.

For example, U.S. Pat. No. 8,241,126B2 discloses a video game controller with swappable modular control input components such as joysticks, trackballs and directional pads. Each input component is connectable to a main controller and provides input data to the main controller based on a user interaction with the input component. In this case, the input components are peripheral devices for the main controller, which is itself a peripheral device to a remote computing device (the game console). Each input component comprises specific control input hardware such as capacitive and/or electromechanical sensors, a microprocessor and sensor circuitry for converting user actions into data that is read by the main controller hardware, and an electrical interface or connector for connecting to an input port of the main controller. As the type of data depends on the type of input component (e.g. joystick, directional pad etc.) control input hardware is also configured to store and provide information indicating which type of input component it is.

Other applications of modular control devices include, but are not limited to, automotive interiors (e.g. steering wheel, centre console, dashboard, and/or door handle control inputs), where it is desirable to provide customisable control interfaces that can be replaced based on the specific needs of the user e.g. accounting for user preferences, use cases and/or physical impairments.

Although known modular control devices provide generally for swappable peripheral input devices, these peripheral input devices generally require integration of a number of various electronic components in both the main and peripheral devices for measuring and processing data as well as means for storing data on the peripheral for identifying the peripheral device. U.S. Pat. No. 10,188,939B2 is another example of a modular control device with a main and peripheral elements, where each peripheral module comprises electronic components including a storage element which stores a module identifier that is collected by the main device.

These peripheral input devices are also limited in their form and function by conventional design restrictions associated with accommodating traditional capacitive sensors, buttons and joysticks. These standard input components generally require electronic circuitry and rely on the presence of a printed circuit board, and a large number of metal wires, traces and electrodes in the peripheral device to provide even relatively simple user input functionality, whereby the number and size of such components typically scales with the device size.

As such, the design freedom of known peripherals is limited and their electronic circuitry often complex. In addition, their manufacture and assembly is both costly and difficult. It is therefore desirable to develop peripheral devices that are simpler and less costly to manufacture and assemble without sacrificing user functionality, and offer greater design freedom in form and function.

Aspects and embodiments of the present invention have been devised with the foregoing in mind.

### SUMMARY OF THE INVENTION

Described herein are peripheral devices that do not require any conventional metal-based electronic components and circuitry to provide the user with input functionalities and can be completely fabricated from conductive and non-conductive thermo-formable materials using traditional moulding processes. This allows sensor structures such as buttons, joysticks and other interactive functionalities to be produced in any desired shape, form, size, appearance and feel, providing almost infinite customisation opportunities that also allow to fundamentally change the aspect of the coherent modular control device and the mode of interaction with it. The peripheral devices described herein, although completely electrically passive, can also be identified by the main device through the use of specific electrical signal patterns obtained from the sensing electrodes once connected to the main device.

According to a first aspect of the invention, there is provided a peripheral input device module that is connectable to a main control device to provide one or more electrical signals to the main control device in response to a user interaction with the peripheral input device module. The peripheral input device module may be a capacitive sensing device configured to provide touch and/or pressure/force-based sensing functions. When connected, the peripheral input device module and main control device may form a coherent modular control device. In the context, a coherent modular control device means a single physical object. The peripheral input device module may be releasably attachable to the main control device to form the coherent modular control device. The peripheral input device module may comprise one or more, or a plurality of sensing electrodes formed of or comprising a thermo-formable non-metallic conductive material. The or each sensing electrode may be configured to provide one or more electrical signals in response to a change in capacitance between (i) a sensing portion of the respective sensing electrode and a conductive object being near to or in contact with the respective sensing portion, and/or (ii) a sensing portion of the respective sensing electrode and a sensing portion of another of the sensing electrodes or another sensing portion of the respective (same) sensing electrode. At least one of the sensing electrodes may comprise one or more connector portions that form an electrical connector for connection to an electrical connector of the main control device. The connector portions may be arranged in an array. Each connector portion may be configured to electrically connect to a respective electrical contact of a capacitive sensing circuit of the main control device for measuring the electrical signals.

In this context non-metallic material means not a metal, or alloy such as a gold or nickel gold, and a thermo-formable material means a material that can be heated to a pliable forming temperature, formed to a specific shape in a mould, and optionally trimmed to create a usable product.

Unlike known peripheral input devices, the capacitive sensing electrodes are formed of a non-metallic conductive thermo-formable material and fulfil both capacitive sensing and electrical connector roles. The conductive sensing portions capacitively interact with other conductive objects, such as a user's finger or another sensing portion (of the same or different sensing electrode), to provide the user input functionality, and the connector portions form an electrical connector for releasably electrically connecting the peripheral device to electrical contacts of a capacitive sensing circuit of the main control device. As such, the signal paths and electrical connection from the capacitive sensing portions to the electrical contacts of the sensing circuit of the main control device are provided entirely by the non-metallic conductive sensing electrodes. This eliminates the need for producing and integrating PCBs, metal tracks and/or wires in the peripheral device. Further, no signal measurement or processing is performed by the peripheral input device. As such, the peripheral input device module can be fully electrically passive and does not require any conventional metal-based electronic circuit components or hardware to provide the user input functionality, such as metal electrodes, connectors, wires or traces, resistors, transistors, capacitors, inductors, diodes, integrated circuits, processors, storage devices, or batteries.

Advantageously, the peripheral input device module can be formed or comprised substantially entirely of non-metallic conductive and non-conductive thermo-formable materials that can be formed by one or more moulding processes into almost any 3D shape and size, and which can be substantially rigid, flexible, and/or pliable/deformable. This allows a wide range of capacitive sensing functionalities to be achieved through suitable design of the conductive sensing electrodes and non-conductive elements of the peripheral device. This also allows the peripheral device to provide a range of “feel” or tactile interface options based on the materials used. As such, the peripheral input device module of the present invention is not limited in form or function by conventional design restrictions imposed on known peripheral input devices that must accommodate various metal-based circuit components and capacitive sensor electrodes. In addition, due its construction of mouldable conductive and non-conductive materials, the peripheral input device module is relatively inexpensive to manufacture and simple to assemble compared to conventional metal-electronic based peripheral input devices.

The sensing electrodes and/or the non-conductive elements may have, at least in part, a three-dimensional form. In this context, a three-dimensional form means a shape with one or more substantially non-planar surfaces and/or a varying (non-uniform) thickness cross-section. The sensing electrodes may have a substantially uniform or non-uniform thickness. For example, the sensing may have a thickness greater than that of a film or coating (such as a printed ink or metal trace/tack on a typical printed circuit board), e.g. greater than 0.5 mm or 1 mm.

The sensing electrodes may be substantially rigid, pliable and/or deformable, and need not all have the same material properties (i.e. mechanical and electrical properties). Suitable materials for the sensing electrodes include but are not limited to conductive plastics, such as conductive thermoplastic polyurethane (TPU), conductive thermoplastic elastomer (TPE), conductive acrylonitrile butadiene styrene (ABS), conductive silicones, conductive polyurethane (PU), and conductive ethylene vinyl acetate (EVA).

The peripheral input device module may comprise various non-conductive elements formed of or comprising a non-conductive thermo-formable material. Non-conductive material may be used to support and retain the sensing electrodes, be formed or provided on/over the sensing portions as a cover or interface layer, and/or be formed or provided between sensing portions. The non-conductive material may be substantially rigid, or flexible, pliable and/or deformable. Suitable materials for the non-conductive elements include, but are not limited to: non-conductive TPU, non-conductive TPE, non-conductive ABS, non-conductive silicones, and fabrics.

The peripheral input device module may comprise a housing. The housing may be formed of or comprise, at least in part, a substantially rigid thermo-formable material. The housing may be non-conductive. The housing may be configured to support and retain the sensing electrodes. The housing may form or comprise an integral connector body portion configured to hold the connector portions in place. The connector body portion may be configured to engage the connector portions to support and hold them in place. The connector body portion may be located on a (connection) side of the housing. The connector body portion may comprise one or more openings, e.g. in the connection side, through which the connector portions extend.

The connector portions may be arranged in an array at the connector body portion. The connector body portion may comprise one or more integral spacer elements that extend between adjacent connector portions to maintain a separation between them. The or each opening may be at least partially defined between adjacent spacer elements. As such, the connector body portion may provide structural/mechanical support for the connector portions and the resulting electrical connector.

The connector body portion may be configured to frictionally or mechanically engage the connector portions. In this case, the or each opening may be further defined between a pair of opposing engagement surfaces configured to frictionally engage the connector portions. The connector body portion may be defined by two separate parts integrally formed with respective separate parts of the housing. Each part of the connector body portion may comprise one of the engagement surfaces such that the one or more openings are formed, and/or the connector portions are gripped or clamped between opposing engagement surfaces, when assembled.

Alternatively, the connector portions may be integral with the connector body portion, e.g. the connector portions may be co-moulded with the connector body portion.

Each connector portion may comprise an exposed contact portion configured to mechanically contact a corresponding electrical contact of the sensing circuit of the main control device to form an electrical connection between them. The exposed contact portions may be configured to electrically contact metallic or non-metallic electrical contacts of the sensing circuit of the main control device. The connector portions may be configured to form an overlapping contact or an end-on contact with the respective electrical contacts of the main control device. The connector portions may be substantially elongated. The exposed contact portion of a connector portion may be provided on a distal end or a side of the connector portion. The exposed contact portion may be configured to mechanically inter-engage with and/or bias against a corresponding electrical contact of the sensing circuit of the main control device. Optionally or preferably, each contact portion may comprise one or more of: a projection, a recess, and a resiliently deformable biasing element such as a spring finger.

The peripheral input device may comprise a non-conductive cover provided on or over at least a portion of the housing. The cover may be formed or comprises a substantially soft, flexible, deformable and/or pliable non-conductive thermo-formable material. The cover may be provided on or over a sensing portion of at least one of the one or more sensing electrodes.

The sensing circuit of the main control device may have a plurality of electrical contacts including at least one ground contact and at least one sense contact for measuring capacitance.

Where there are a plurality of sensing electrodes, at least one of them may be configured as a ground electrode having a connector portion configured to connect to a ground contact of the sensing circuit of the main control device. The ground electrode may be configured to provide a ground plane. The ground plane may have one or more sensing portions configured to capacitively interact with another sensing electrode of another sensing electrode.

At least one sensing electrode without a connector portion may be configured to electrically or mechanically contact a sensing electrode with a connector portion, optionally the ground electrode, to connect to the sensing circuit of the main control device.

The ground electrode may have two or more connector portions wherein at least one of the two or more connector portions is configured to connect to a ground contact of the sensing circuit of the main control device and at least one other of the two or more connector portions is configured to connect to a respective sense contact of the sensing circuit of the main control device. When connected to the main control device, the ground electrode may be configured to electrically short the respective sense contact(s) of the main control device to ground. In doing so, this may provide a predefined electrical signal pattern or sequence at the electrical contacts of the sensing circuit of the main control device for identifying the peripheral input device module from other peripheral input device modules. The connector portions may be arranged in an array and the at least one other of the two or more connector portions of the ground electrode may be arranged in a predefined position in the array to provide the predefined electrical signal pattern or sequence.

Using electrical signal patterns to identify the peripheral device eliminates the need for conventional on-board storage elements that are used to store device IDs in conventional peripheral input devices.

The peripheral input device module may comprise a locking mechanism configured to engage a locking mechanism of the main control device to releasably attach the peripheral input device module to the main control device, optionally or preferably, by mechanical engagement and/or magnetic attraction. The connector body portion of the housing may form or comprise the locking mechanism. The connector body portion may comprise one or more locking elements configured to inter-engage with complementary locking elements of the main control device. Additionally or alternatively, the connector body portion may comprise one or more magnets configured to engage one or more magnets of opposite polarity on the main control device.

The locking mechanism may be or comprises a slide rail mechanism. The array of connection portions, electrical connector and/or the connector body portion may extend for a length along a side of the peripheral input device module in a connection or slide direction. The one or more locking elements may comprise one or more male or female rail members that extend at least part of the length of the connector body portion in the slide or connection direction. The rail members may be configured to slidingly engage one or more complementary rail members of the main control device.

A first sensing portion of a first sensing electrode may be configured to move relative to a second sensing portion of a second sensing electrode or second sensing portion of the first sensing electrode, in response to an applied force or pressure. Relative movement between said first and second sensing portions may cause the change in capacitance between them. The first and second sensing portions may be separated by a distance and relative movement between them may change the distance. The first and second sensing portions may be separated by a gap, or a substantially deformable, flexible, and/or pliable thermo-formable non-conductive material may be provided between them.

One of the first or second sensing portions may comprise a collapsible element. The collapsible element may be configured to collapse and resiliently deform in response to an applied force or pressure at or above a threshold. A first applied force or pressure below the threshold may change a distance or separation between the first and second sensing portions and provide a first change in the capacitance. A second applied force or pressure (greater than the first force/pressure) at or above the threshold may collapse the collapsible element and provide a second change in the capacitance (greater than the first change) and/or tactile feedback to the user. Optionally or preferably, proximity of a conductive object to at least one of the first and second sensing electrodes may cause a third change in capacitance (less that the first and second change). A layer of substantially deformable, flexible, and/or pliable thermo-formable non-conductive material may be provided on or over the collapsible element. The collapsible element may be substantially dome-shaped. Optionally or preferably, the first or second sensing electrode with the collapsible element may be configured to provide a ground plane when connected to the main control device.

The housing may comprise one or more openings. A sensing portion of at least one of the sensing electrodes may extends at least partially into or through at least one of the one or more openings for receiving a user interaction.

Alternatively or additionally, the peripheral input device module comprises a movable actuator. The movable actuator may extend through one of the one or more openings to a sensing portion of at least one of the sensing electrodes. The actuator may be configured to receive a user interaction and to transmit the user interaction to a sensing portion within the housing. The actuator may be formed of or comprise one or more thermo-formable materials. The actuator may be formed of or comprise multiple sub-parts that are assembled together.

The movable actuator may be or comprise a joystick. The joystick may comprise a handle portion that extends through the one of the one or more openings and a base portion located within the housing. The base portion may comprise a first sensing electrode. The base portion or joystick may be configured to pivot about a fulcrum to move a sensing portion of the first sensing electrode relative to a set of second sensing portions distributed about the fulcrum. Each second sensing portion may be associated with a (different) respective second sensing electrode, where each second electrode may include a connector portion. Pivoting of the base portion or joystick may cause a change in capacitance between the first sensing portion and (one or more of) the second sensing portions and thereby provide one or more electrical signals for detecting a tilt direction and angle of the joystick with respect to the housing.

The first sensing electrode of the base portion may not include a connector portion and may be configured to connect to an electrical contact of the sensing circuit of the main control device through electrical contact with a fourth sensing electrode which does include a connector portion. The connector portion of the fourth sensing electrode may be configured to connect to a ground contact of the sensing circuit of the main control device. The fourth sensing electrode may be configured as a ground electrode or a ground plane.

The fulcrum may be formed of a non-metallic conductive or non-conductive thermo-formable material. The fulcrum may be integral with the housing or the fourth sensing electrode. Where the fulcrum is integral with the fourth sensing electrode, the first sensing electrode of the base portion may be configured to connect to an electrical contact of the sensing circuit of the main control device through electrical or mechanical or physical contact with the fulcrum. Where the fulcrum is integral with the housing, the first sensing electrode of the base portion may be configured to electrically contact the fourth sensing electrode through a connector element.

The joystick may be moveable between a lower (or inner) position (with respect to the housing) in which the first sensing portion capacitively interacts with the set of first sensing portions disposed below the first sensing portion for detecting a tilt angle and direction, and an upper (or outer) position (with respect to the housing) in which the first sensing portion capacitively interacts with the set of third sensing portions disposed above the first sensing portion for detecting a translation of the joystick in one or more lateral directions. The joystick may be moveable between a lower position in which the base portion or joystick is pivotable about the fulcrum for detecting a tilt direction and angle of the joystick, and an upper position in which the base portion or joystick is translatable in one or more lateral directions with respect to the fulcrum to move the sensing portion of the first sensing electrode relative to a set of third sensing portions distributed about the fulcrum or handle portion. The set of third sensing portions may be disposed above the first sensing portion/electrode or base portion. Each third sensing portion may be associated with a (different) respective third sensing electrode, where each third electrode may include a connector portion. Translation of the base portion or joystick may cause a change in capacitance between the first sensing portion and (one or more of) the third sensing portions and thereby provide one or more electrical signals for detecting a translation of the joystick in one or more lateral directions with respect to the housing.

The joystick may further comprise a resiliently deformable biasing element configured to bias the joystick to a rest position and deform to permit movement of the joystick away from the rest position. The rest position may include an angular position and optionally a rest lateral position. The joystick may be aligned with a rest axis that insects the fulcrum when in the rest position. The rest position may include the lower (or inner) position. The resiliently deformable element may be formed of or comprise a non-metallic conductive thermo-formable material or a non-conductive thermo-formable material. Where it is formed of a metallic conductive thermo-formable material it may be integral with, or in electrical contact with, the first sensing electrode. The resiliently deformable element may be or comprise a spiral spring, or a disk-like member. Alternatively, there may be a plurality of resiliently deformable biasing elements distributed about the joystick.

A non-conductive material may be provided on or over a sensing portion of at least one of the one or more sensing electrodes. The non-conductive material may be formed of or comprise a thermo-formable non-conductive material. The thermo-formable non-conductive material may be substantially rigid or substantially flexible, deformable or pliable.

According to a second aspect of the invention there is provided a modular control system. The modular control system may comprise a main control device and one or more peripheral input device modules of the first aspect. The one or more peripheral input device modules may be configured to interchangeably connect and/or attach to the main control device to provide one or more electrical signals to the main control device in response to a user interaction with a connected peripheral input device module. When connected, a peripheral input device module and main control device may form a coherent modular control device. The main control device module may comprise a capacitive sensing circuit configured to measure the one or more electrical signals provided by a connected peripheral input device module. The capacitive sensing circuit may comprise a plurality of electrical contacts for connecting to the connector portions of the one or more peripheral input device modules. The plurality of electrical contacts may form at least part of an electrical connector of the main control device for connecting to the electrical connector of the one or more peripheral input device modules. The main control device may comprise an electrical connector comprising a plurality of electrical contacts of the capacitive sensing circuit. Each electrical contact may be configured to electrically contact a respective connector portion of the connected peripheral input device module.

The electrical contacts of the capacitive sensing circuit may be configured to mechanically contact an exposed contact portion of a respective connector portion to establish an electrical connection therebetween. Each electrical contact of the capacitive sensing circuit may be configured to abut, inter-engage with and/or bias against the exposed contact portion of a respective connector portion. Optionally or preferably, each electrical contact of the capacitive sensing circuit and/or the contact portion of the respective connector portion may comprise one or more of: a projection, a recess, and a biasing element.

The electrical contacts of the capacitive sensing circuit may be formed of or comprise a metal or metallic material. The electrical contacts may comprise a metal or metallic contact pad and/or a metal or metallic mechanical biasing element such as a spring finger or pogo pin. The electrical contacts of the capacitive sensing circuit may further comprise non-metallic conductive thermo-formable material. The non-metallic conductive thermo-formable material may be provided over and/or extend from the metal electrical contact. The electrical contacts may further comprise a connection element formed of or comprising a non-metallic conductive thermo-formable material for contacting the connector portions of the peripheral device. The connection element may be provided over and/or extend from a metal or metallic contact pad. The connection element may be or comprise a contact pad and/or a mechanical biasing element such as a spring finger.

The main control device may comprise a locking mechanism configured to engage a locking mechanism of the one or more peripheral input modules to releasably attach a peripheral input device module to the main control device. Optionally or preferably, the locking mechanisms of the main control device and the one or more peripheral input device modules are or comprise a sliding rail mechanism.

The main control device may further comprise a microcontroller in communication with the capacitive sensing circuit. The microcontroller may be configured to receive and process measurement data from the capacitive sensing circuit. The microcontroller may further be configured to determine one or more user interactions with the connected peripheral input device module based on the measurement data.

The main control device may be configured to communicate with an external or remote computing device (via a wired or wireless network) for controlling one or more operations of the external computing device based on the measured one or more electrical signals. The main control device may comprise a wireless communication module in communication with the microcontroller for communicating with the external computing device. The modular control system may comprise the external computing device. The external computing device may be configured to execute one or more operations based on the one or more user interactions with the connected peripheral input device module determined by the main control device. The external computing device may be configured to receive and process measurement data transmitted from the main control device. The external computing device may be configured to determine one or more user interactions with the connected peripheral input device module based on the measurement data.

The microcontroller or external computing device may further be configured to process the measurement data and determine a unique identifier of the connected peripheral input device module based on detection of a predefined electrical signal pattern or sequence at the electrical contacts of the capacitive sensing circuit, e.g. upon connection of the peripheral input device module to the main controller device.

The main control device may be or form at least part of: a game console, a control system for a vehicle interior, or a computer peripheral.

According to a third aspect of the invention, there is provided a method of manufacturing the peripheral input device module of the first aspect. The method may comprise forming the one or more sensing electrodes from a non-metallic conductive thermo-formable material. The method may further comprise forming a housing with an integral connector body from a thermo-formable material. The housing may be non-conductive. The method may further comprise forming a non-conductive cover from a substantially soft, flexible, deformable and/or pliable non-conductive thermo-formable material. The method may further comprise assembling the one or more sensing electrodes, the housing, and/or the cover to provide, form or produce the peripheral input device module.

The one or more sensing electrodes, the housing, and/or the cover may be formed by a moulding process. The moulding process may include one or more of injection moulding, compression moulding and over-moulding. The sensing electrodes, housing and cover can be moulded as separate elements which are then assembled together, or at least some of those elements can be moulded together. For example, at least one of the sensing electrodes (e.g. a ground plane sensing electrode) can be moulded, and the housing moulded onto it/them in an over-moulding process. Additionally or alternatively, the cover can be over-moulded onto the housing. Additionally or alternatively, non-conductive spacers layers can be over-moulded onto one or more sensing electrodes (or sensing portions of a sensing electrode).

According to a fourth aspect of the invention, there is provided a method of sensing an electrical signal using the peripheral input device module of the first aspect. The method may comprise selectively bringing a conductive object near to, in contact with and/or across a sensing portion of a sensing electrode, and/or selectively applying a force or pressure to the peripheral input device module to cause relative movement between a sensing portion of a sensing electrode and a sensing portion of another sensing electrode or another sensing portion of the same sensing electrode.

According to a fifth aspect of the invention, there is a provided a sensor device for providing one or more electrical signals in response to a (touch and/or force pressure) user interaction with the sensor device. The sensor device may comprise one or more, or a plurality of sensing electrodes formed of or comprising a thermo-formable non-metallic conductive material. The or each sensing electrode may be configured to provide (e.g. at one or more measurement points on the respective sensing electrode) one or more electrical signals in response to a change in capacitance between: (i) a sensing portion of the respective sensing electrode and a conductive object being near to or in contact with the respective sensing portion, and/or (ii) a sensing portion of the respective sensing electrode and a sensing portion of another one of the sensing electrodes or another sensing portion of the respective (same) sensing electrode. The device may comprise a first sensing electrode and a second sensing electrode.

A first sensing portion of the first sensing electrode may be configured to move relative to a second sensing portion of the second sensing electrode in response to an applied force or pressure. Relative movement between said first and second sensing portions may cause the change in capacitance between them. The first and second sensing portions may be separated by a distance and relative movement between them may change the distance between them. The first and second sensing portions may be separated by a gap, or a layer of substantially deformable, flexible, and/or pliable non-conductive thermo-formable material may be provided between them. The first and second sensing portions may be associated with respective first and second sensing electrodes, which may have respective connector portions. One of the first and second sensing portions may comprise a collapsible element. The collapsible element may be configured to collapse and resiliently deform in response to an applied force or pressure at or above a threshold. The layer of substantially deformable, flexible, and/or pliable non-conductive thermo-formable material may be provided on or over the collapsible element, or between the collapsible element of the first or second sensing portion and the other of the first or second sensing portion. A first applied force or pressure below the threshold may change a distance or separation between the first and second sensing portions and provide a first change or first range of change in the capacitance and/or a first range of signal level change. A second applied force or pressure (greater than the first force/pressure) at or above the threshold may collapse the collapsible element and provide a second change in the capacitance and/or a second signal level change (greater than the first change) and/or tactile feedback to the user. Optionally or preferably, proximity of a conductive object to at least one of the first and second sensing electrodes may cause a third change in capacitance (less that the first and second change). The collapsible element may be substantially dome-shaped. Optionally or preferably, the first or second sensing electrode with the collapsible element may be formed of or comprise a substantially deformable, flexible, and/or pliable non-metallic conductive thermo-formable material. The other of the first or second sensing electrodes may be formed of a substantial rigid non-metallic conductive thermo-formable material.

The sensing electrodes may be connectable or configured to connect to a capacitive sensing circuit for measuring the electrical signals. At least some of the sensing electrodes may comprise a connector portion for electrically connecting to a respective electrical contact of a capacitive sensing circuit for measuring the electrical signals. Establishing an electrical connection to the electrical contacts of a capacitive sensing circuit may be achieved as described in the first or second aspect. The sensor device may or may not include the capacitive sensing circuit. Where it includes the capacitive sensing circuit, the sensor device may further comprise a microcontroller for receiving measurement data from the capacitive sensing circuit, and optionally processing the measurement data to determine one or more touch or pressure/force-based user interactions with the sensor device.

According to a sixth aspect of the invention, there is provided a sensing device for providing one or more electrical signals in response to a user interaction with the sensor device. The sensor device may comprise a plurality of sensing electrodes formed of or comprising a non-metallic conductive thermo-formable material. The sensing electrodes may be configured to provide (e.g. at one or more measurement points on the respective sensing electrode) one or more electrical signals in response to a change in capacitance between a sensing portion of the respective sensing electrode and a sensing portion of another one of the sensing electrodes. The sensor device may be or comprise a joystick device configured to provide one or more electrical signals for detection of tilt angle and tilt direction, and/or lateral translation of the joystick.

The sensor device may comprise a joystick. The joystick may be formed of or comprise one or more thermo-formable materials. The joystick may comprise a handle portion and a base portion. The sensor device may comprise a housing with an opening. The base portion may be located within the housing and the handle portion may extend from the base portion through the opening in the housing for receiving a user interaction or force from a user. The base portion may comprise a first sensing electrode. The base portion and/or joystick may be configured to pivot about a fulcrum to move a sensing portion of the first sensing electrode relative to a set of second sensing portions distributed about the fulcrum. The set of second sensing portions may be distributed equally, evenly and/or symmetrically about the fulcrum. Each second sensing portion may be associated with a (different) respective second sensing electrode, where each second electrode may include a connector portion. The set of second sensing portions may be located below the base portion and first sensing portion. Pivoting of the base portion or joystick may cause a change in capacitance between the first sensing portion and (one or more of) the second sensing portions and thereby provide one or more electrical signals for detecting a tilt direction and angle of the joystick, e.g. with respect to the housing.

The joystick may be moveable between a lower position in which the base portion or joystick is pivotable about the fulcrum for detecting a tilt direction and angle of the joystick, and an upper position in which the base portion or joystick is translatable in one or more lateral directions with respect to the fulcrum to move the sensing portion of the first sensing electrode relative to a set of third sensing portions distributed about the fulcrum or handle portion. The set of third sensing portions may be disposed above the first sensing portion/electrode and/or base portion and/or set of second sensing electrodes. The set of third sensing portions may be distributed equally, evenly and/or symmetrically about the fulcrum or handle portion (when in a rest position). Each third sensing portion may be associated with a (different) respective third sensing electrode, where each third electrode may include a connector portion. Translation of the base portion or joystick when in the upper position may cause a change in capacitance between the first sensing portion and (one or more of) the third sensing portions and thereby provide one or more electrical signals for detecting a translation of the joystick in one or more lateral directions with respect to the housing.

The joystick may further comprise a resiliently deformable biasing element configured to bias the joystick to a rest position in the absence of force applied to the handle portion and deform to permit movement of the joystick away from the rest position in response to a force applied to the handle portion. The rest position may include a rest angular position and optionally a rest lateral position. The joystick may be aligned with a rest axis that insects the fulcrum when in the rest position. The set of second and/or third sensing electrodes may be distributed about the rest axis. The resiliently deformable biasing element may be configured to bias the joystick against the fulcrum in the rest position. The rest position may include the lower position. The resiliently deformable element may be formed of or comprise a non-metallic conductive thermo-formable material or a non-conductive thermo-formable material. Where it is formed of a non-metallic conductive thermo-formable material it may be integral with, or electrically contact, the first sensing electrode. The resiliently deformable element may be or comprise a spiral spring, or a disk-like member. Alternatively, there may be a plurality of resiliently deformable biasing elements distributed about the joystick.

At least some of the sensing electrodes may comprise a connector portion for electrically connecting to a respective electrical contact of a capacitive sensing circuit for measuring the electrical signals. Establishing an electrical connection to the electrical contacts of a capacitive sensing circuit may be achieved as described in the first or second aspect. The sensor device may or may not include the capacitive sensing circuit. Where it includes the capacitive sensing circuit, the sensor device may further comprise a microcontroller for receiving measurement data from the capacitive sensing circuit, and optionally processing the measurement data to determine one or more user interactions with the sensor device, e.g. including one or more of tilt angle, tile direction, lateral translation direction and lateral translation amount.

The set of second and/or third sensing electrodes may comprise respective connector portions. The first sensing electrode of the base portion may not include a connector portion and may be configured to connect to an electrical contact of the capacitive sensing circuit through electrical, mechanical and/or physical contact with a fourth sensing electrode which does include a connector portion. The connector portion of the fourth sensing electrode may be configured to connect to a ground contact of the sensing circuit of the main control device. The fourth sensing electrode may be configured as a ground electrode or a ground plane.

The fulcrum may be formed of a non-metallic conductive thermo-formable material or a non-conductive thermo-formable material. Wherein the fulcrum is non-conductive, it may be integral with the housing. Where the fulcrum is conductive, it may be integral with a fourth sensing electrode. Where the fulcrum is integral with the fourth sensing electrode, the first sensing electrode of the base portion may be configured to electrically connect to an electrical contact of the capacitive sensing circuit through mechanical or physical contact with the fulcrum. Where the fulcrum is integral with the housing, the first sensing electrode of the base portion may be configured to electrically contact the fourth sensing electrode through a connector element.

Features which are described in the context of separate aspects and embodiments of the invention may be used together and/or be interchangeable. Similarly, where features are, for brevity, described in the context of a single specific embodiment, these may also be provided separately or in any suitable sub-combination. Features described in connection with the peripheral input device module may have corresponding features definable with respect to the method(s) and sensor devices, and vice versa, and these embodiments are specifically envisaged.

### BRIEF DESCRIPTION OF DRAWINGS

In order that the invention can be well understood, embodiments will now be discussed by way of example only with reference to the accompanying drawings, in which:

FIG. 1 shows a schematic diagram of a modular control system according to an embodiment of the invention;

FIGS. 2(a) and 2(b) show generic touch sensing electrode configurations in a peripheral input device module;

FIG. 2(c) shows electrical signals associated with the configuration of FIG. 2(b);

FIG. 2(d) shows a generic pressure sensing electrode configuration in a peripheral input device module;

FIGS. 3(a) to 3(c) show the operation of another sensing electrode configuration for touch and pressure sensing;

FIG. 3(d) shows an electrical signal associated with the interactions shown in FIGS. 3(a) to 3(c);

FIG. 4 illustrates a first example peripheral input device module according to an embodiment;

FIG. 5 shows an exploded view of the peripheral input device module of FIG. 4;

FIG. 6 shows a cross-section of the peripheral input device module of FIG. 4 connected to a main control device;

FIG. 7 shows the peripheral input device module of FIG. 4 in a partially assembled state;

FIGS. 8(a) to 8(c) illustrate steps of connecting the peripheral input device module to a main control device;

FIGS. 9(a) and 9(b) show examples of shorting different sensing electrodes of the peripheral input device module to ground for device identification;

FIGS. 9(c) and 9(d) illustrate the corresponding electrical signals measured by the main control device for the sensing electrode configurations of FIGS. 8(a) and 8(b) respectively;

FIGS. 10(a) to 10(c) illustrate the electrical signals measured by the main control device when the peripheral input device modules is disconnected, connected and disconnected again, respectively, for device detection;

FIG. 11(a) illustrates a second example of a peripheral input device module according to an embodiment;

FIG. 11(b) shows an exploded view of the peripheral input device module of FIG. 11(a);

FIG. 12(a) illustrates a third example of a peripheral input device module according to an embodiment;

FIG. 12(b) shows an exploded view of the peripheral input device module of FIG. 12(a);

FIG. 13(a) illustrates a fourth example of a peripheral input device module according to an embodiment;

FIG. 13(b) shows an exploded view of the peripheral input device module of FIG. 13(a);

FIGS. 14(a) to 14(c) show schematic cross-sections of a joystick sensing element according to an embodiment;

FIGS. 15(a) to 15(c) show how the joysticks of FIGS. 14(a)-14(c) operate;

FIGS. 16(a) to 16(c) show how a tilt direction of the joysticks of FIGS. 14(a)-14(c) is determined from the measured electrical signals;

FIGS. 17(a) to 17(c) show cross-sections of a joystick sensing element according to another embodiment in different positions;

FIGS. 18(a) to 18(c) show how a lateral translation direction of the joystick of FIGS. 17(a)-17(c) is determined from the measured electrical signals;

FIGS. 19(a) to 19(c) show schematic cross-sections of example slide rail-type connector configurations for a peripheral input device module;

FIGS. 20(a) and 20(b) show schematic cross-sections of example plug and socket-type connector configurations for a peripheral input device module;

FIGS. 21(a) to 21(e) show example ways of electrically connecting a conductive plastic electrical contact portion of the peripheral input device to a metal electrical contact; and

FIGS. 22(a) to 22(d) show example ways of electrically connecting a conductive plastic electrical contact portion of the peripheral input device to another conductive plastic electrical contact; and

FIG. 23 shows a method of manufacturing the peripheral device.

It should be noted that the figures are diagrammatic and may not be drawn to scale. Relative dimensions and proportions of parts of these figures may have been shown exaggerated or reduced in size, for the sake of clarity and convenience in the drawings. The same reference signs are generally used to refer to corresponding or similar features in modified and/or different embodiments.

### DETAILED DESCRIPTION

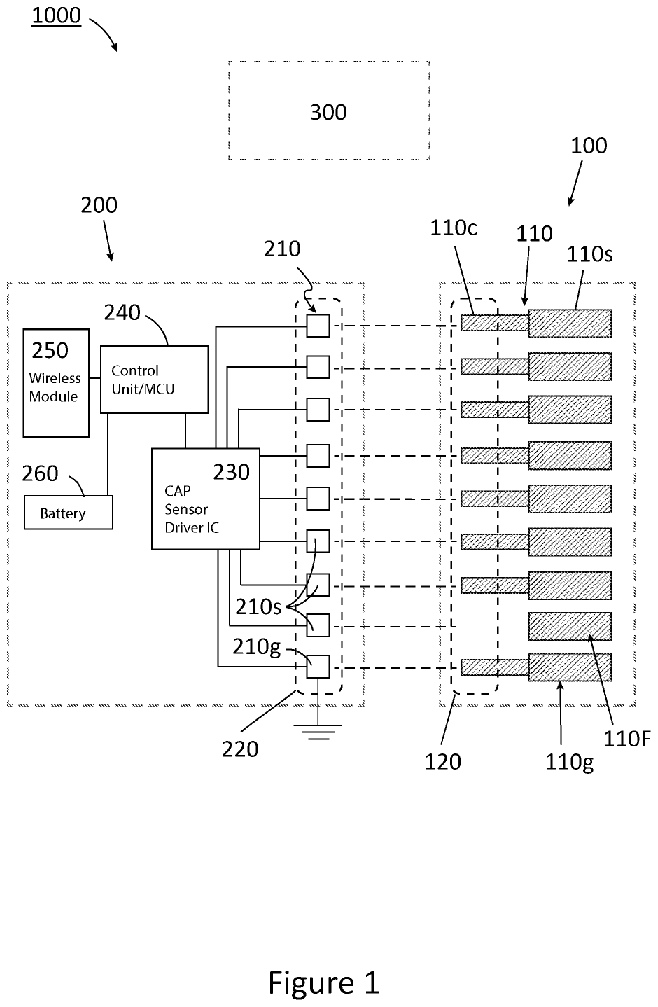

FIG. 1 shows a schematic diagram of a modular control system 1000 according to an embodiment of the invention. The system 1000 comprises a main control device 200 and a peripheral input device module 100 (referred to hereafter as a main device and peripheral device, respectively, for brevity). The peripheral device 200 and the peripheral device 100 are physically separate devices or device modules that are connectable or attachable to one another to form a single coherent modular control device. The peripheral device 100 is configured to provide one or more electrical signals to the main device 200 in response to a user interaction with the peripheral device 100. When connected, the main device 200 measures the electrical signals produced by the peripheral device 100 and can process them to determine or interpret the user interaction with the peripheral device 100 and generate one or more control signals based on the determined user interaction. The control signals may be used for controlling one or more processes, operations or functions of the main device 200 or of a remote computing device 300 in wired or wireless communication with the main device 200. Alternatively, depending on the application, the main device 200 may be considered to send measurement data to the remote device 300 for processing.

In general, the main device 200 may take different shapes/forms, serve different functions and comprise conventional electronic components. For example, the main device 200 may be a standalone computing device with or without its own user input functionalities, or it may itself be a peripheral input device with its own user input functionalities for controlling the remote computing device 300. The main device 200 may be a substantially portable and/or hand held device, e.g. the main device 200 may be a portable or mobile computing device (e.g. a laptop, tablet, or smart phone), a wired or wireless controller (e.g. a gaming and/or virtual reality controller), or a computer peripheral. Alternatively, the main device 200 may be substantially non-portable, such as a control console (e.g. part of an automotive interior control console, such as a customisable control interface for a steering wheel).

The peripheral device 100 extends the functionality of the main device 200 to include a set of specific functions provided by the peripheral device 100. In practice, the system 1000 may comprise one or more peripheral devices 100 that are interchangeably connectable to the main device 200. Each peripheral device 100 can be configured with a different three-dimensional (3D) shape/form and function based on the application to allow the size, shape, appearance, and functionality of modular control device to change.

The peripheral device 100 is a capacitive sensing device configured to provide various touch and/or pressure/force-based sensing functions. Touch and/or pressure-based user interactions with the peripheral device 100 cause a change in the one or more electrical signals that is measurable by the main device 200.

Unlike known peripheral input devices, the peripheral device 100 is electrically passive (i.e. requires no on-board power source to operate) and does not contain any conventional metal-based electronic circuit components, such as metal electrodes, wires or traces, resistors, transistors, capacitors, inductors, diodes, integrated circuits, processors, storage devices, or batteries. Instead, the peripheral device 100 can be made exclusively from thermo-formable conductive and non-conductive materials, such as plastic and rubber materials that can be formed by one or more moulding processes into almost any 3D shape and size and can be substantially rigid, flexible, and/or pliable/deformable. This allows a wide range of capacitive sensing functionalities to be achieved through suitable design of the thermo-formable conductive sensing electrodes and non-conductive elements of the peripheral device 100, as described in more detail below.

The peripheral device 100 comprises a plurality of sensing electrodes 110 configured to provide electrical signals to the main device 200 in response to a touch and/or pressure-based user interactions with the peripheral device 100. The sensing electrodes 210 are formed of or comprise a thermo-formable non-metallic conductive material that can be formed by one or more moulding processes such as injection moulding or compression moulding. The sensing electrodes 110 may be substantially rigid, pliable and/or deformable, and need not all have the same material properties (i.e. mechanical and electrical properties). Suitable materials for the sensing electrodes include but are not limited to conductive plastics, such as conductive thermoplastic polyurethane (TPU), conductive thermoplastic elastomer (TPE), conductive acrylonitrile butadiene styrene (ABS), conductive silicones, conductive polyurethane (PU), and conductive ethylene vinyl acetate (EVA). Throughout the accompanying figures, the sensing electrodes 110 appear as shaded elements for clarity.

Each sensing electrode 110 comprises at least one sensing portion 110s configured to capacitively interact with a conductive object 400 such as a user's finger and/or another sensing portion 110s on the same or a different sensing electrode 110. As such, the one or more electrical signals are provided in response to (i) a change in capacitance between a sensing portion 110s of the respective sensing electrode 110 and a conductive object 400 being near to or in contact with the respective sensing portion 110s, and/or (ii) a change in capacitance between a sensing portion 110s of the respective sensing electrode 110 and a sensing portion 110s of another sensing electrode 110 or another sensing portion 110s of the (same) respective sensing electrode 110.

At least some of the sensing electrodes 110 comprise one or more at least partially exposed connector portions 110c that form an electrical connector 120 for electrically connecting the peripheral device 100 to the main device 200. Each connector portion 110c is configured to electrically connect directly to respective electrical contact 210 of the capacitive sensing circuit 230 of the main device 200 (as described in more detail below).

Sensing electrodes 110 that do not comprise a connector portion 110c, e.g. sensing electrode 110F in FIG. 1, are configured to electrically contact a sensing electrode 110 which does have a connector portion 110c in order to connect to the sensing circuit 230 of the main device 200. The electrical contact between such electrodes 110 is mechanical, i.e. made through direct physical contact between respective sensing electrodes 110F, 110g. In practice, this can be achieved through simple abutment, or a (non-metallic) fastener can be used and secure the respective sensing electrodes 110F, 110g together and maintain contact (not shown).

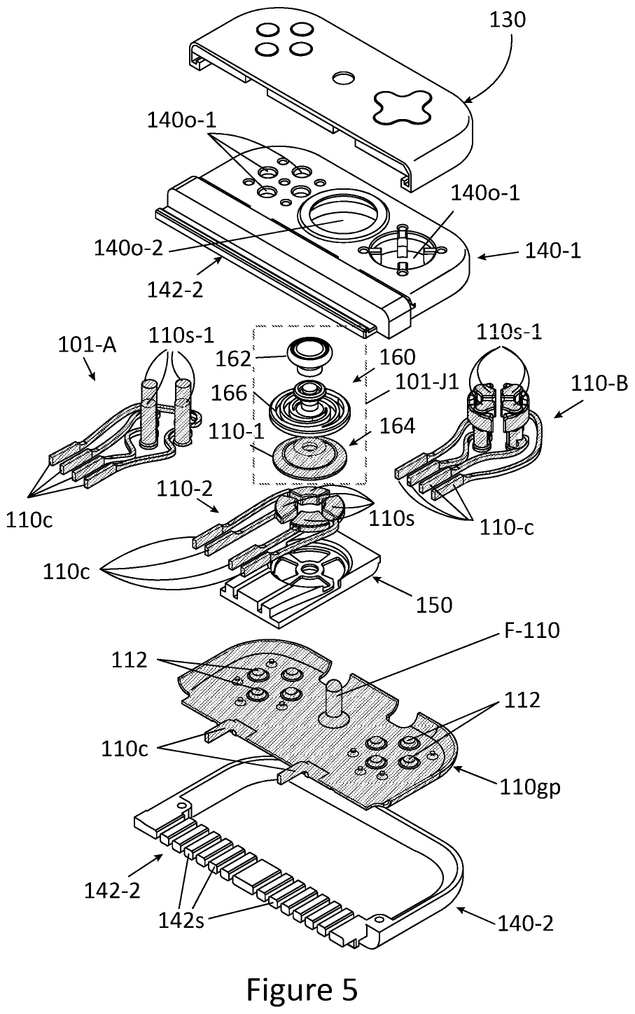

At least one sensing electrode 110 with a connector portion 110c is configured to connect to a ground electrode 210g of the main device 200 to be a ground electrode 110g. Preferably, at least one ground electrode 110g is configured as a ground plane 110gp for the peripheral device 100, with an extended area that overlaps other sensing electrodes 110 (e.g. see FIG. 5). The ground plane 210gp serves to shield the other sensing electrodes 110 from the external environment and thereby reduces noise and interference in the electrical signals. The ground electrode 110g or ground plane 110gp may also have one or more sensing portions 110s that capacitively interact with sensing portions 110s on other sensing electrodes 110 and thus also play an active role in the sensing functionalities, as described below.

Optionally, a sensing electrode 110F that does not comprise a connector portion 110c can conveniently be configured as a ground electrode through contact with the ground electrode 210g, as shown.

The peripheral device 100 also comprises various non-conductive elements that are used to support and retain the sensing electrodes 110, be provided on/over the sensing portions 110s as a cover or interface layer, and/or be provided between sensing portions 110s, as will be described in more detail below. The non-conductive elements of the peripheral device 100 are formed of or comprise one or more thermo-formable non-conductive materials that can similarly be formed by one or more moulding processes such as injection moulding, compression moulding, over-moulding and/or heat press. For example, non-conductive material may be over-moulded onto one or more of the sensing electrodes 110 or vice versa. The non-conductive material may be substantially rigid, or flexible, pliable and/or deformable. Suitable materials for the non-conductive elements include but are not limited to non-conductive TPU, non-conductive TPE, non-conductive ABS, non-conductive silicones, and fabrics.

With reference to FIG. 1, the main device 200 comprises a capacitive sensing circuit 230 for measuring the electrical signals provided by the connected peripheral device 100. The capacitive sensing circuit 230 comprises a capacitive sensing chip and an array of electrical contacts 210 for connecting the sensing electrodes 110 of the peripheral device 100 to the capacitive sensing chip. The array of electrical contacts 210 form part of an electrical connector 220 for connecting with the electrical connector 120 of the peripheral device 100. Each electrical contact 210 is configured to electrically connect to the respective connector portions 110c of the sensing electrodes 110, as will be described in more detail below.

The array of electrical contacts 210 comprise a plurality of sense contacts 210s connected to sensing channels of the capacitive sensing chip and at least one ground contact 210g connected to a ground pin of the capacitive sense chip. The capacitive sensing chip can measure changes in self-capacitance at a sensing contact 210s for the touch sensing functions, and/or changes in capacitance between a pair of sense contacts 210s or between a sense contact 210s and a ground contact 210g for the mechanical pressure sensing functions. The capacitance measurement may be a time or frequency-based measurement, as is known in the art.

The main device 200 also comprises a control unit or microcontroller 240 in data communication with the capacitive sensing chip, and a power management unit 260 for powering the main device 200. The control unit 240 is configured to receive measurement data from the capacitive sensing circuit 230. The power management unit 260 may be connectable to a battery, or the power management unit may comprise a re-chargeable battery.

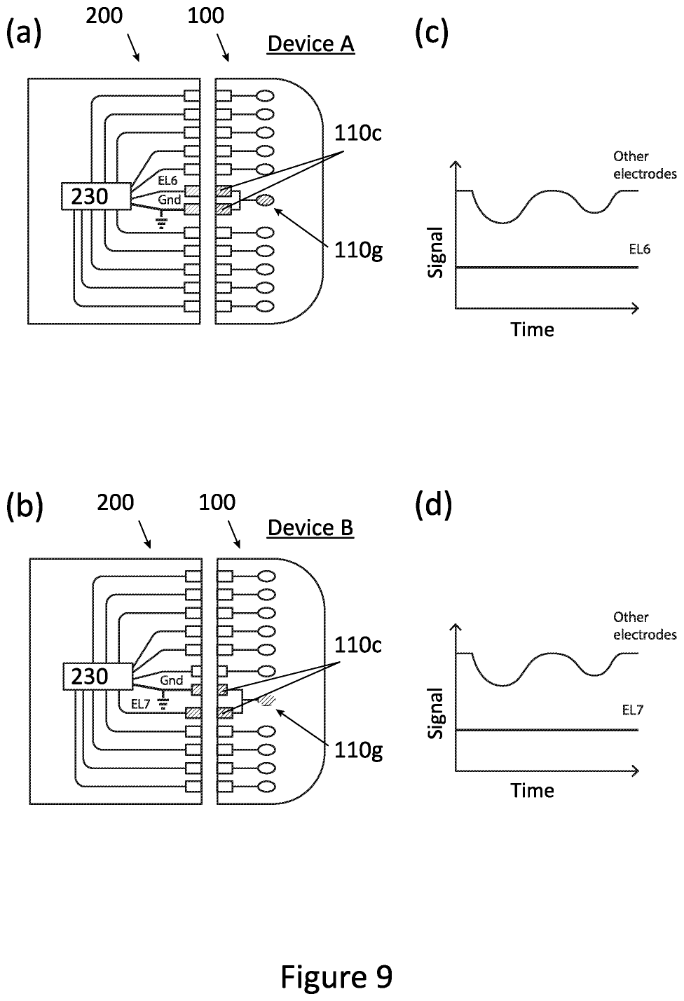

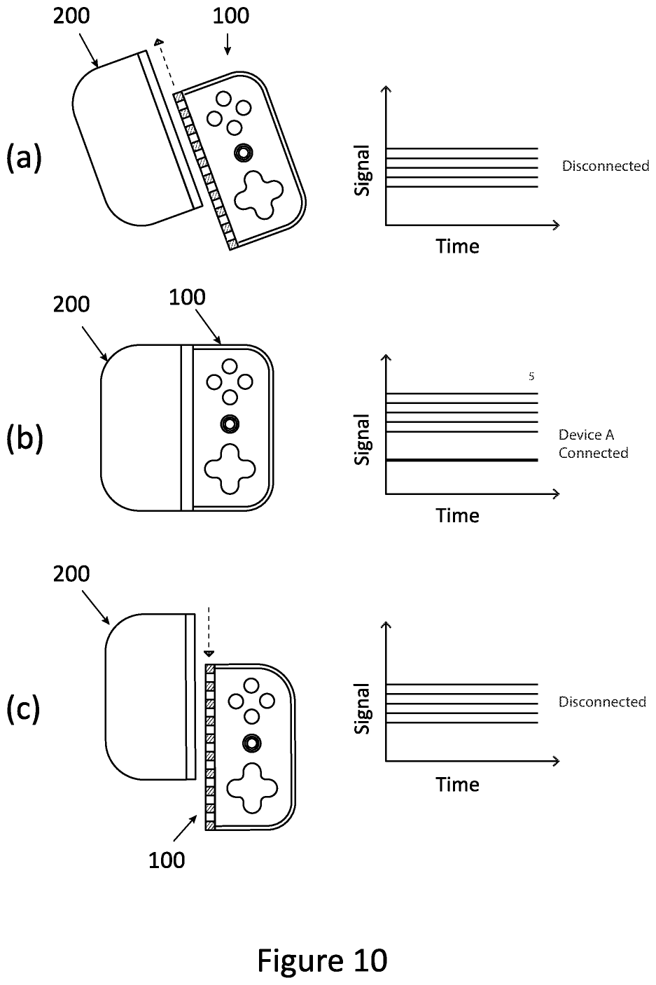

The measurement data gathered from the capacitive sensing chip is processed or analysed to determine one or more user interactions with the connected peripheral device 100. Processing of the measurement data can be performed on-board the main device 200 by the control unit 240 or at the remote computing device 300, where present. Where processing is performed on the main device 200, the control unit 240 comprises a processor and a memory (not shown) for storing one or more software programs or program instructions, that when executed or run on the processor causes the control unit 240 to process and/or analyse the measurement data to determine a user interaction with the peripheral device 100 based on the measurement data. For example, the control unit 240 may be configured to determine or detect one or more of: a contact or touch from a user/operator, a contact/touch position, a speed, direction and/or amount of movement of said touch for a touch sensing functions; and/or a movement/deformation, direction of movement/deformation, and/or amount of movement/deformation of a sensing portion 110s relative to another sensing portion 210s of the same or different sensing electrode 210 for a mechanical pressure sensing functions. The control unit 240 is also configured to detect when a peripheral device 100 is attached and identify the specific connected peripheral device 100 based on the measured electrical signals (described in more detail below with reference to FIGS. 9(a) to 10(c)). The identity of the connected peripheral device 100 is used (e.g. by the software program) to interpret the measurement data and determine the user interaction. Processing and/or analysing the measurement data may comprise filtering, smoothing, differentiating, peak finding and/or comparing data to one or more predefined thresholds or functions. The control unit 240 may then be configured to generate one or more control/command signals based on the determined user interaction(s) for controlling one or more functions/operations of the main device 200 or remote computing device 300 (where present in the system 1000).

The main device 200 may also include a wireless communication unit 250 in data communication with the control unit 240 for communicating with a remote computing device 300 over a wireless network (e.g. Bluetooth, Bluetooth low energy, or WiFi). For example, the wireless communication unit 250 can be used to send any control signals or other data generated/determined by the control unit 240 to the remote computing device 300, and/or to send measurement data collected from the capacitive sensing chip to the remote computing device 300 for processing as described above.

It will be appreciated that the main device 200 may also comprise various other hardware components not shown, depending on the purpose and function of the main device 200. For example, the main device 200 may further comprise a vibration motor for providing tactile or haptic feed to the user, a haptic driver for the vibration motor, and an inertial measurement unit (IMU) for detecting motion or movement of the main device 200. The IMU may comprise an accelerometer, gyroscope and/or a magnetometer (e.g. the IMU may have 3, 6 or 9 degrees of freedom), as is known in the art.

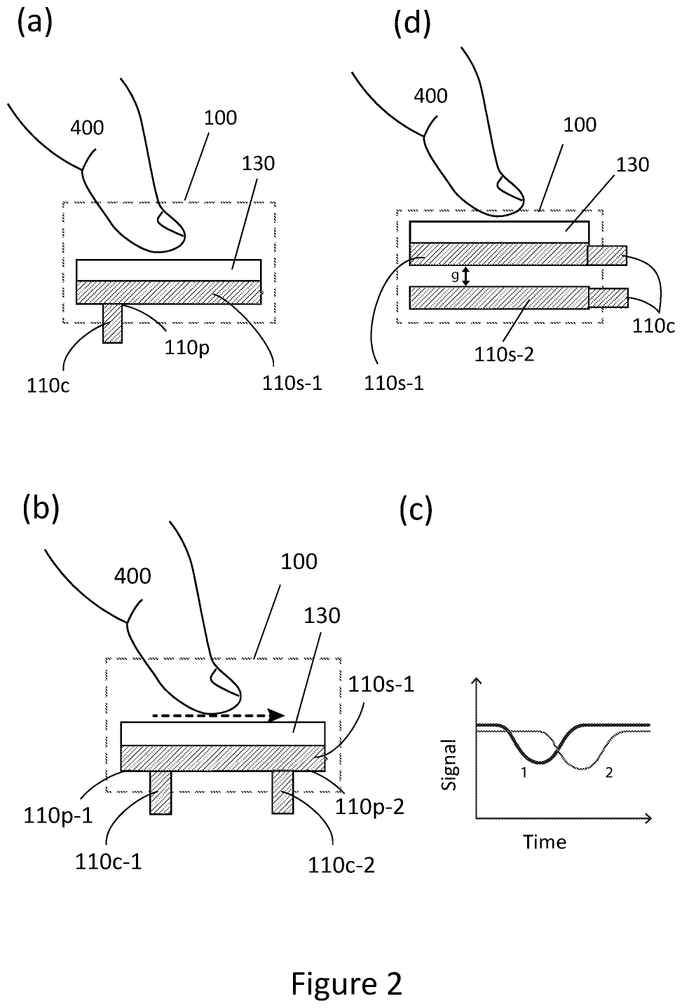

FIGS. 2(a) to 2(d) illustrate the basic capacitive touch and pressure/force sensing concepts implemented by various embodiments of the peripheral device 100. FIG. 2(a) shows a generic touch sensing configuration. In FIG. 2(a), a layer of non-conductive material 130 is provided on or over a first sensing portion 110s-1 of a sensing electrode 110 as an interface or cover layer. When a conductive object 400 such as a user's finger comes into proximity with the sensing portion 110s-1, such as by touching the non-conductive material 130, the capacitive interaction between the sensing portion 110s-1 the finger 400 changes the self-capacitance of the sensing portion 110s-1, which can be measured by the main device 200 at the connector portion 110c. The change in the measured electrical signal can therefore be used to detect a touch interaction with the peripheral device 100.

In general the material properties (mechanical and/or electrical properties) of the connector portion(s) 110c may be the same or different to the sensing portion 110s of the respective sensing electrode 110. For example, different material properties can be achieved by forming the sensing electrodes 110 using an over-moulding or co-moulding process. The connector portion 110c should be highly conductive to minimise signal attenuation (e.g. an electrical resistivity of less than 1 k Ohm/cm). Preferably the sensing portion 110s is also highly conductive. In this case it behaves like an equipotential such that the signal produced by a touch interaction is substantially independent of the touch location on the sensing portion 110a (as is the case for conventional metal capacitive sensing electrodes). This is suitable for simple touch detection. Alternatively, in certain applications the conductivity of the sensing portion 110s can be substantially lower (i.e. more resistive) than the connector portion 110s (e.g. an electrical resistivity of greater than 1 k Ohm/cm). In this case the signal produced by a touch interaction exhibits a dependence on the touch location relative to the sensing point 110p where the connector portion 110c meets the sensing portion 110s. This effect is illustrated in FIGS. 2(b) 2(c) which show a sensing electrode 110-1 with two connector portions 110c-1, 110c-2 which probe the capacitance at first and second respective sensing points 10l1p-1, 110p-2 and the signals measured at the connector portions 110s-1, 110s-2 as a user's finger 400 moves across the non-conductive material 130 provided over the sensing portion 110s-1. The maximum signal change occurs when the touch location coincides with the respective sensing point 110p-1, 110p-2 and decays as the touch location moves away from the respective sensing point 110p-1, 110p-2.

More complex/advanced touch sensing functions can be achieved, such as detection of touch position, speed, direction and/or amount of movement of said touch position, by using a plurality of highly conductive sensing electrodes 110, or a sensing electrode 110 with a substantially resistive sensing portion 110s.

FIG. 2(d) shows a generic pressure/force sensing configuration. In FIG. 2(d), a first sensing portion 110s-1 of a first sensing electrode 110-1 and second sensing portion 110s-1 of a second sensing electrode 110-2 (which alternatively can also be of the first sensing electrode 110-1) are separated by a distance g. A layer of non-conductive material 130 is again provided on or over the first sensing portion 110s-1 as a cover or interface layer. In this configuration, the first sensing portion 110s-1 is configured to move relative to the second sensing portion 110s-2 in response to a force or pressure applied by the user's finger 400 which changes the distance g. This changes the capacitance between the sensing portions 110s, which can be measured by the main device 200. The capacitance between the sensing portions 110s increases as the distance g is reduced, and the measured electrical signal can therefore be used to detect a pressure/force interaction. The two sensing portions 110s-1, 110s-2 may be separated by gap as shown (e.g. an empty space or void), or a layer of resiliently deformable/compressible non-conductive material, such as silicone, can be provided between the sensing portions 110s-1, 110s-2 (not shown). Touch interactions with the first sensing portion 110s-1 (with negligible applied force or pressure) can be also be detected in the same way as described above for FIG. 2(a).

In both sensing touch and force sensing configurations, the non-conductive material 130 provided over the first sensing portion 110s-1 can be substantially rigid or resiliently deformable/compressible.

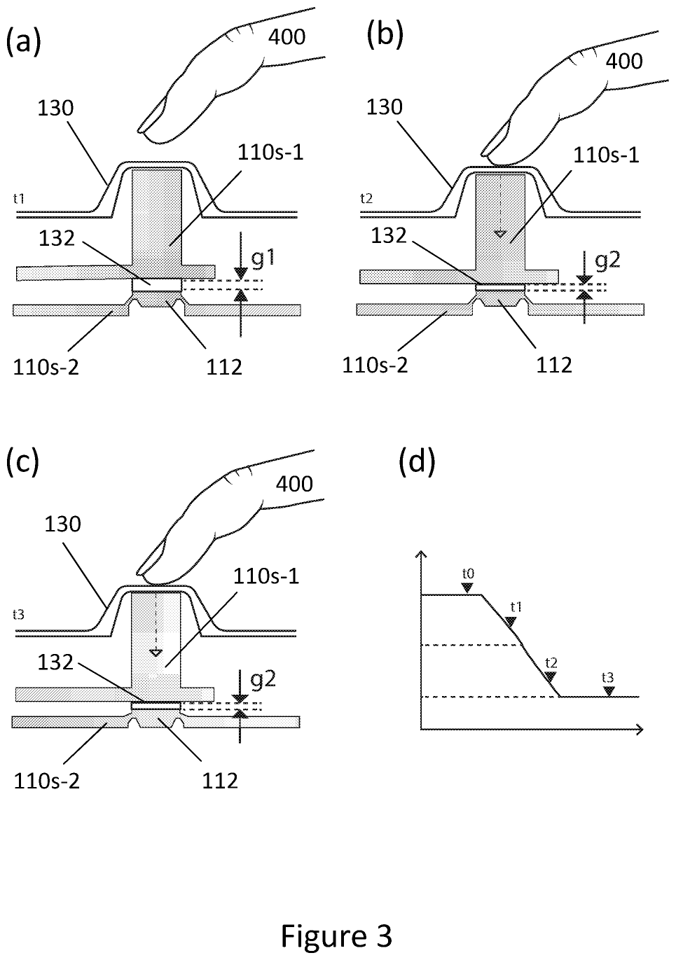

FIGS. 3(a) to 3(c) show a variation of the configuration in FIG. 2(c) in which the first and second sensing portions 110s-1, 110s-2 are separated by a resiliently deformable/compressible non-conductive spacer 132 and the second sensing portion 110s-2 comprises a substantially dome-shaped collapsible element 112 configured to collapse and resiliently deform in response to an applied threshold force or pressure. A non-conductive cover layer 130 is provided over the first sensing portion 110c-1. The second sensing portion 110s-2 with the collapsible element 112 is formed of or comprises a substantially flexible and/or deformable conductive thermo-formable material, such as conductive silicone. Likewise, the spacer 132 is formed of or comprises a substantially deformable non-conductive thermo-formable material, such as silicone. The collapsible element 112 provides an additional change in the signal level and tactile feedback to the user when the threshold force/pressure is applied, e.g. to provide a confirmation click or sensation. In this way, three signal level changes are achieved dependent on the force applied, as illustrated in FIG. 3(d). At time t0, no user interaction is occurring and the first and second sensing portions 110s-1, 110s-2 are separated by a first distance g1. At time t1 the user's finger 400 is brought into proximity and capacitively interacts with the first sensing portion 110s-1, as shown in FIG. 3(a), providing a first level of signal change. At time t2 the user applies a force/pressure to the cover layer 130 below the threshold. This applied force compresses the spacer 132 such that the first and second sensing portions 110s-1, 110s-2 are separated by a second distance g2<g1, providing a second level of signal change. At time t3 the user applies a force/pressure to the cover layer 130 at or above the threshold. This applied force collapses the collapsible element 132 and provides a third level of signal change and tactile feedback to the user.

The first and second sensing portions 110s-1, 110s-2 are preferably associated with separate respective first and second sensing electrodes 110-1, 110-2 and the second sensing electrode 110-2 with the collapsible element 132 is optionally or preferably a ground electrode 110g or a ground plane 110gp.

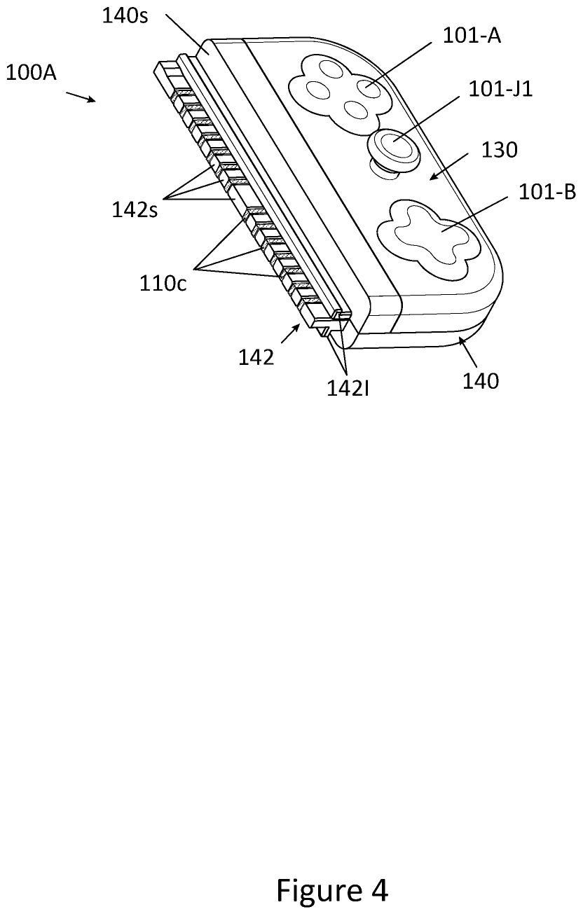

FIG. 4 illustrates a specific embodiment of a peripheral device 100A. FIG. 5 shows an exploded view of the peripheral device 100 of FIG. 4. The peripheral device 100A is configured to provide a plurality of different sensing elements 101 for receiving user inputs including touch and pressure sensitive buttons 101-A, 101-B and a joystick 101-J1, as will be described in more detail below.

The peripheral device 100A comprises a plurality of sensing electrodes 110, a housing 140, a cover 130, and a movable actuator 160 in the form of a joystick. The housing 140 is formed of a substantially rigid non-conductive thermo-formable material (e.g. non-conductive ABS) and is configured to support and retain the sensing electrodes 110. The cover 130 is formed of a substantially soft and resiliently deformable/pliable non-conductive thermo-formable material, such as non-conductive silicone, and is provided over at least a portion of the housing 140 to provide a tactile “soft touch” interface layer.

The housing 140 comprises a plurality of openings 140o-1 through which one or more sensing portions 110s at least partially extend for receiving a user interaction such as a touch or applied pressure/force. The housing 140 further comprises an opening 140o-2 through which the movable actuator 160 extends for receiving a user interaction (i.e. a force that moves the actuator 160) and transmitting the user interaction to one or more respective sensing portion 110s located within the housing 140 for detection, as will be described in more detail below.

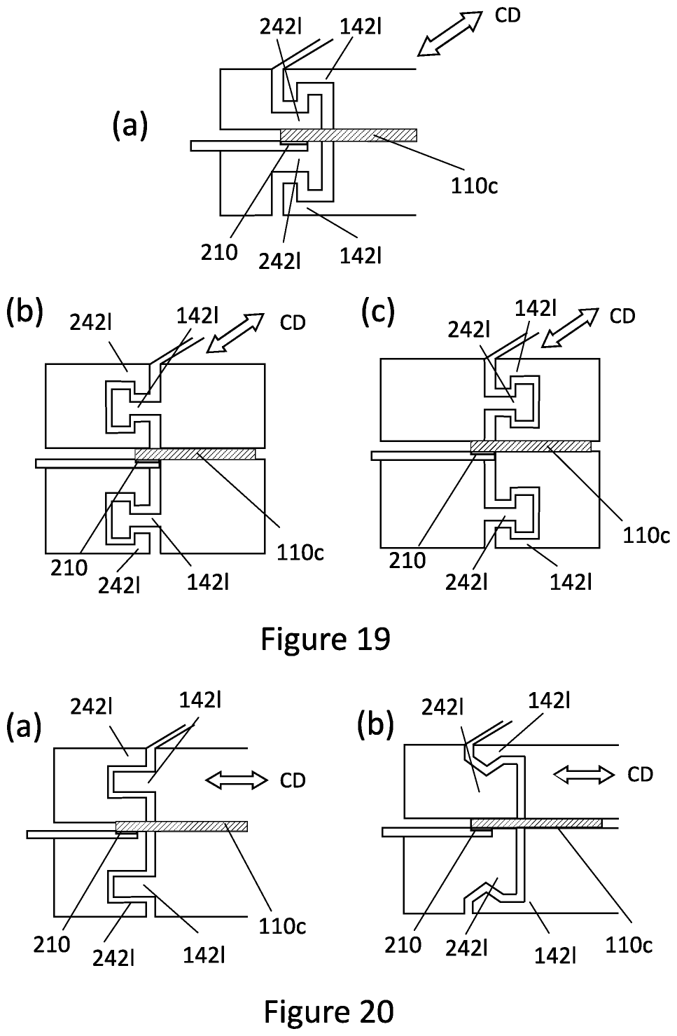

In the illustrated embodiment, the touch and pressure sensitivity input buttons 101-A, 101-B operate as described above with reference to FIGS. 3(a) to 3(d). As such, each input button 101-A comprises a respective first sensing electrode 110-1 and a second sensing electrode, which in this embodiment is provided by a single sensing electrode configured as a ground plane 110g. Each opening 140o-1 receives the first sensing portion 110s-1 of the first sensing electrode 110-1 of a respective input button 101-A to allow a force to be applied to it through the opening 140o-1 to change the separation g between it and the ground plane 110g. The ground plane 110g comprises a plurality of collapsible elements 112 associated with the respective buttons 101-A. Each collapsible element 112 is configured to collapse and resiliently deform in response to a threshold force/pressure applied to the first sensing portion 110s-1 of the respective button 101-A. As such, the sensing electrode 110g forming the ground plane is formed of a substantially flexible and resilient deformable conductive thermo-formable material, such as conductive silicone. A non-conductive spacer 132 formed of resiliently deformable non-conductive thermo-formable material, such as non-conductive silicone, is provided between each associated collapsible element 112 and first sensing portion 110s-1. Operation of the joystick 101-J1 will be described in detail below with reference to FIGS. 19(a) to 21(c).

The soft cover 130 is provided over the openings 140o-1 to inhibit ingress of dust and water/moisture while allowing a force to be applied to the underlying sensing portion 110s-1. In the illustrated embodiment, the actuator 160 also extends through an opening in the cover 130, however, the soft cover 130 may instead also be provided over the actuator 160 (not shown).

The housing 140 comprises an integral connector body portion 142 configured to engage the connector portions 110c of the sensing electrodes 110 to support and hold them in place.

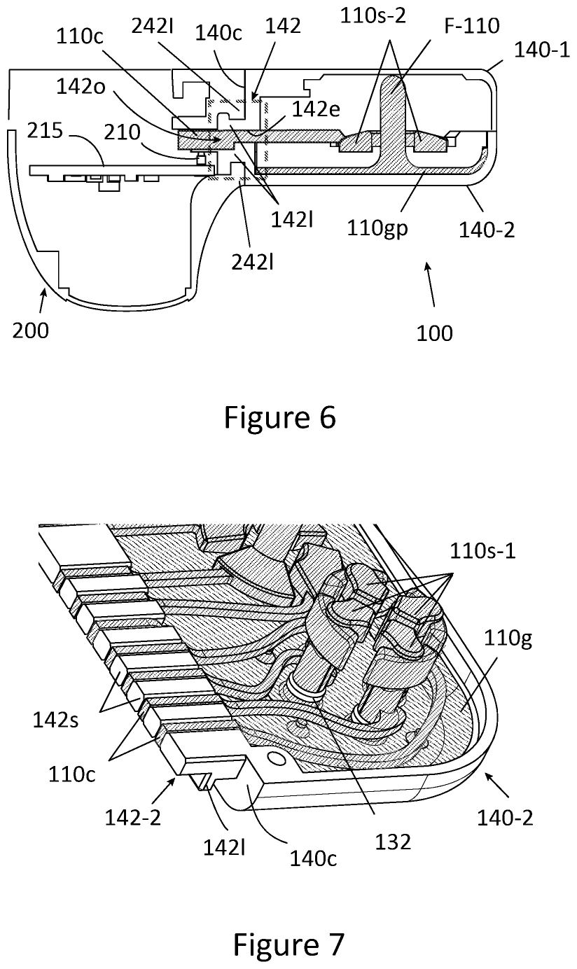

FIG. 6 shows a cross-section of an example control device formed by the connection of the peripheral device 100A of FIG. 4 to an example main device 200, showing the connector body portion 142 more clearly. The connector body portion 142 is located on a connection side 140c of the housing 140 and comprises one or more openings 142o in the connection side 140c through which the connector portions 110s extend.

The connector portions 110c can be held in place by frictional engagement, or they can be integrally formed with the connector body portion 142 through a co-moulding process. In the embodiment of FIGS. 5 and 6, the connector body portion 142 is defined by two separate parts 142-1, 142-2 integrally formed with respective separate parts 140-1, 140-2 of the housing 140 that are secured together during assembly of the peripheral device 100. In this case, to retain the connector portions 110s by frictional engagement, the opening 142o can be defined/formed between a pair of opposing engagement surfaces 142e on respective parts 142-1, 142-2 of the connector body portion 142 that frictionally engage and grip the connector portions 110c when assembled. Alternatively, the connector portions 110 can be integrally formed with one of the connector body portions 142-1, 142-2 (not shown). In another embodiment (not shown), the connector body portion 142 is not formed from two parts, but is integrally formed with one of the one or more parts 140-1, 140-2 of the housing 140. In this case, the connector portions 110s can be integrally formed with the connector body portion 142.

FIG. 7 shows the peripheral device 100A of FIG. 4 in a partially assembled/disassembled state without the upper housing part 140-1 in place. The connector portions 110c are arranged in an array that extends for a length along the connection side 140c of the housing 140 (see also FIG. 4). In this embodiment, the connector body portion 142 comprises integral spacer elements 142s disposed between adjacent connector portions 110c to position them and maintain a separation between them. In the illustrated embodiment, the spacer elements 142s are integrally formed with lower part 142-2 of the connector portion 142 to simplify assembly.

With reference to again to FIG. 5, a non-conductive support element 150 with one or more recesses or projections can also be provided within the housing 140 to provide additional support for one or more the sensing electrodes 110. Additionally or alternatively, the housing 140 may comprise one or more recesses and/or projections that cooperate with one of more sensing electrodes 110 to help position and support them (not shown).

The connector body portion 142 of the housing 140 also forms/provides an attachment or locking mechanism configured to engage a corresponding locking mechanism of the main device 200 to releasably attach the peripheral device 100A to the main device 200. In the embodiment of FIG. 4, the connector body portion 142 forms a sliding rail mechanism comprising locking members 1421 with a profile configured to direct sliding inter-engagement with complementary locking members 2421 of the main device 200 in a connection direction CD substantially parallel to the array of connector portions 110c.

The locking members 1421 form rail members that extend at least part of the length of the connector body portion 142 in the connection direction CD and are configured to slidingly inter-engage the complementary rail members 2421 of the main device 200. The rail members 1421 comprise a longitudinally extending projection configured to be received by and engage with a longitudinally extending recess or channel of the respective rail members 2421 of the main device 200, or vice versa.

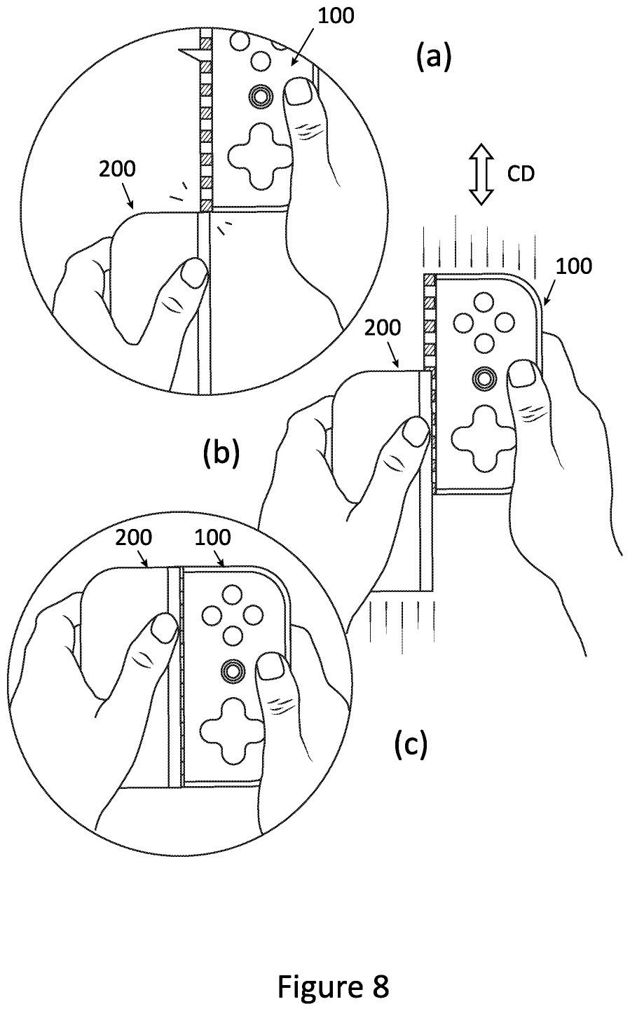

FIGS. 8(a) to 8(c) illustrate how the peripheral device 100A attaches to the main device. In first step, a longitudinal end of the rail members 1421 of the peripheral device 100A is aligned with a longitudinal end of the rail members 2421 of the main device 200, as shown in FIG. 8(a). In a second step, the longitudinal end of the rail members 1421 of the peripheral device 100A is inserted into a longitudinal end of the main device 200 and the continued movement in the connection direction CD causes sliding engagement of the respective rail member 1421, 2421 until a connected position is reached, as shown in FIGS. 8(b) and 8(c).

Sliding engagement of the rail members 1421, 2421 brings the connector portions 110c into physical electrical contact with the respective electrical contacts 210 of the main device 200 establishing an electrical connection therebetween, as described in more details below. An end (frictional) stop or other means can be provided at an end of the rail members 142, 2421 of the peripheral device and/or main device 200 to prevent sliding past the connected position in which the connector portions 110c and electrical contacts 210 are aligned (not shown). Frictional engagement of the rail members 1421, 2421 inhibits unintentional movement away from the connected position. Disconnection or disengagement of the peripheral device 100A from the main device 200 requires applying a force in the opposite direction.

In the embodiment of FIG. 6, the electrical connectors 210 of the main device 200 are metal connectors comprising a biasing element in the form of a spring finger configured to bias against the non-metallic connector portions 110c to establish and maintain a stable electrical contact therebetween. However, it will be appreciated there are a number of alternative ways to establish a releasable electrical connection between the non-metallic connector portions 110c of the peripheral device 100A and metal or non-metallic electrical contacts 210 of the main device 200, as will be described further below with reference to FIGS. 26(a) to 27(d).

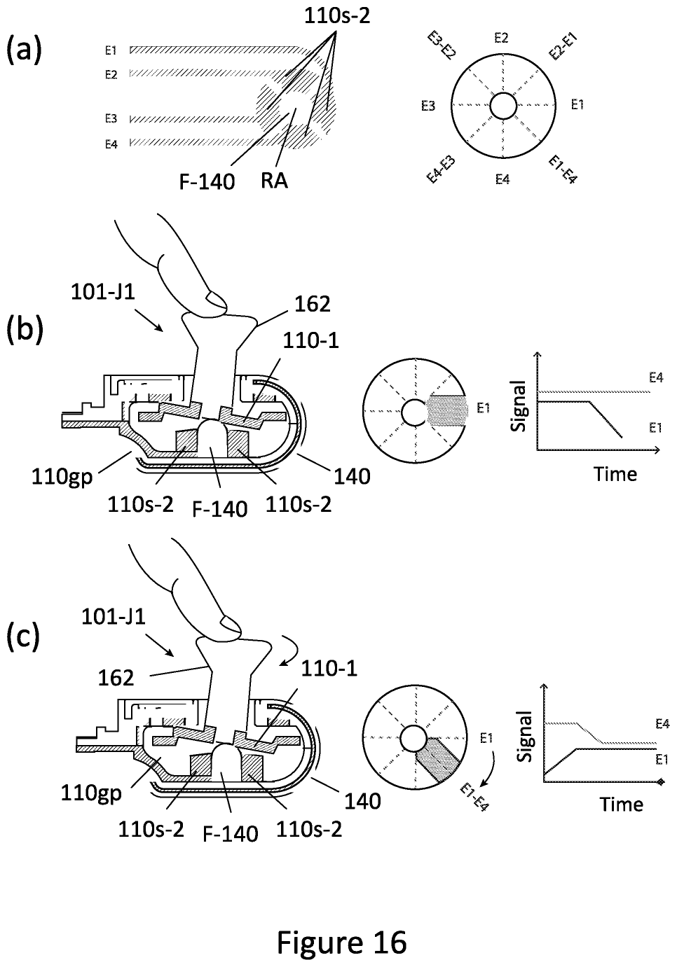

A number of different peripheral devices 100 may be interchangeably connectable to the main device 200, with each peripheral device 100 having a different sensing electrode 110 configuration for providing different modular control devices with different user interaction functionalities (see FIGS. 16 to 18 described below). It is therefore necessary for the main device 200 (or the remote computing device 300) to be able to identify the particular connected peripheral device 100 in order to know how to interpret/analyse the measurement data and determine the user interactions.

When connected, a number of connector portions 110c will be in contact with an equal number of electrical contacts 210 including at least one ground contact 210g as described above. The peripheral devices 100 are configured so that at least one sensing electrode 110 is physically connected to both the ground contact 210g and one of more sense contacts 210s of the sensing circuit to provide a specific signal pattern or sequence detectable by the control unit 240 of the main device 200 (or by the remote computing device 300) for identifying the particular connected peripheral device 100.

FIGS. 9(a) and 9(b) show how two different peripheral devices 100, labelled device A and device B, connected to the main device 100 can be distinguished. A sensing electrode configured as a ground electrode 110g, which may be a ground plane, comprises two or more connector portions 110c, in this example two connector portions 110c. One of the connector portions 110c is configured to connect to a ground contact 210g (Gnd) of the main device 200 and the other is configured to connect to a respective sense contact 210s of the main device 200 (contact EL6 in device A and contact EL7 in device B). In this way, when the devices 100, 200 are connected, the ground electrode 110g shorts the specific respective sense contact(s) 210s to ground and thereby provides a specific signal pattern or sequence at the sense contacts 210s of the sensing circuit of the main device 200 which can be detected and used to identify the specific peripheral device 100 from other peripheral devices 100. The capacitive sensing chip measures the signals at each sensing electrode 210s and those connected to ground provide a distinct signal timecourse and level which can readily be distinguished from those which are not, as illustrated in FIGS. 9(c) and 9(d). In the above example, the control unit 240 (or remote computing device 300) would detect or determine that contact EL6 is grounded when device A is connected and contact EL7 is grounded when device B is connected. This detected signal pattern can be compared to a list of stored signal patterns associated with different peripheral devices 100 to identify the specific connected peripheral device 100. The ground electrode 110g can be configured with any number of connector portions 110c positioned in predefined locations in the array of connector portions 110c to connect to different sensing contacts 210s and provide different unique signal patterns.

The different signal patterns at the sense contacts 210s of the main device 200 can also be used to identify when a peripheral device 100 is connected to the main device 200 or not. This is illustrated in FIGS. 10(a) to 10(c). When the peripheral device 100 is disconnected, all the raw signals measured at the sense contacts 210s are at a baseline level representative of a current “untouched” capacitance of the sense contact 210s. When a peripheral device 100 is connected, the ground electrode 110g shorts specific respective sense contact(s) 210s to ground providing a number of signals with distinct timecourses and levels which are distinguishable from their respective baselines levels. This is detectable by the control unit 240 (or remote computing device 300) and indicates a peripheral device 100 is connected. Once disconnected, all the measured signals are restored to their baseline levels indicating that no peripheral device is connected. In order to differentiate between a peripheral device 100 being connected or not in this way, the control unit 240 (or remote computing device 300) should be configured to obtain raw measurement data from the capacitive sensing chip 230, rather than implementing an adaptive automatic baselining system. With an adaptive automatic baselining system, the signals from each shorted sense contact 210s would be automatically updated to a (predefined) baseline level (as soon as the peripheral device 100 connects to the main device 200) inhibiting the ability to recognise whether a device 100 is attached purely through the signal pattern.

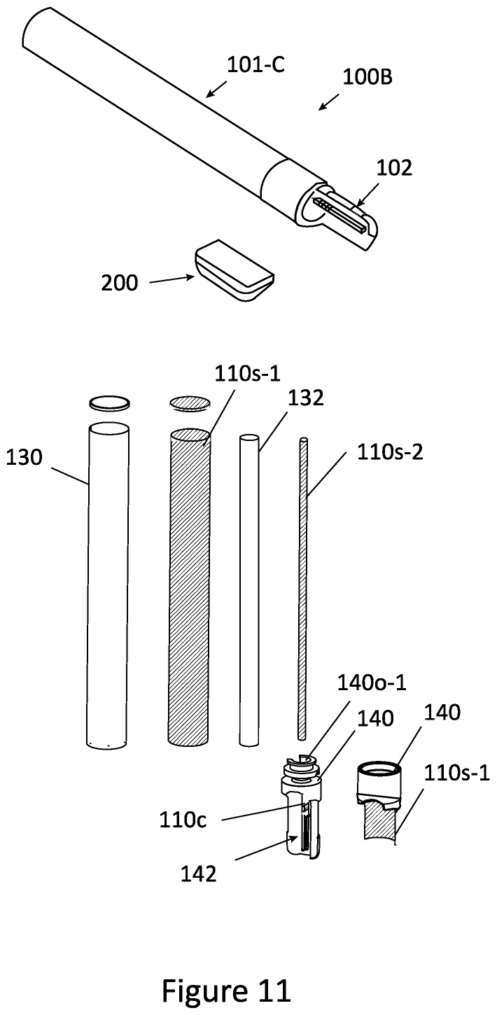

FIGS. 11(a) to 13(b) show different specific embodiments of a peripheral device 100B, 100C, 100D. Similar to peripheral device 100A described above, each peripheral device 100B, 100C, 100D comprises one or more sensing elements 101 for receiving a user input and providing electrical signals to the main device 200, but has a different 3D shape, size, and configuration of sensing electrodes 110 and non-conductive elements with different material characteristics (e.g. for different tactile “feel”) to provide a coherent modular control device with different user interaction functionalities. Each peripheral device 100A, 100B, 100C, 100D comprises an electrical connector 120 and a sliding rail mechanism for interchangeably connecting to the same main device 200. As such, each peripheral device 100A, 100B, 100C, 100D fundamentally changes how the user uses and interacts with the modular control device.

In the embodiment of FIG. 11(a), the peripheral device 100B configured as a sword-like device with a blade portion 101-C and a handle portion 102. The blade portion 101-C is a sensing element 101 for providing electrical signals to the main device 200 in response to touch, force or pressure applied to the blade portion 101-C, e.g. through an impact between the blade portion 101-C and an object which may be another peripheral device 100.

FIG. 11(b) shows an exploded view of the peripheral device 100B. The handle portion 102 comprises a rigid non-conductive housing 140 with a connector body portion 142 and a sliding rail mechanism for attaching to a main device 200. The blade portion 101-C operates in a similar way to that described with reference to FIG. 2(d). In this case, the first and second sensing portions 110s-1, 110s-2 are separated by a spacer 132 formed of substantially deformable non-conductive thermo-formable material and the first (outer) sensing portion 110s-1 is covered by a cover 130 formed of substantially deformable non-conductive thermo-formable material. The first sensing portion 110s-1 is formed of substantially soft or deformable (e.g. formed of conductive EVA) and the second portion 110-2 is substantially rigid (e.g. formed of conductive ABS). The second (inner) sensing portion 110s-2 is substantially cylindrical, and the spacer 132, first sensing portion 110s-1 and cover 130 are concentric hollow cylindrical elements configured to fit over each other in order, as indicated in FIG. 11(b). The sensing portions 110s-1, 110s-2 extend through an opening 140o-1 in the housing 140 where the connector portions 110c of the respective sensing electrodes 110-1, 110-2 are supported and retained by the connector body portion 142. Another sensing portion 110s-1 may also be provided in or on the housing 140 as shown. This sensing electrode 110-1 can be exposed or isolated from the outside by a non-conductive material, e.g. the housing 140 or a cover 130 (not shown). This additional sensing electrode 110-1 can be used as an additional sensing element for detecting when the handle portion 102 is being gripped or held by a user, e.g. operating as described with reference to FIG. 2(a). Alternatively, this sensing electrode 110-1 can be used as a ground plane 110gp.

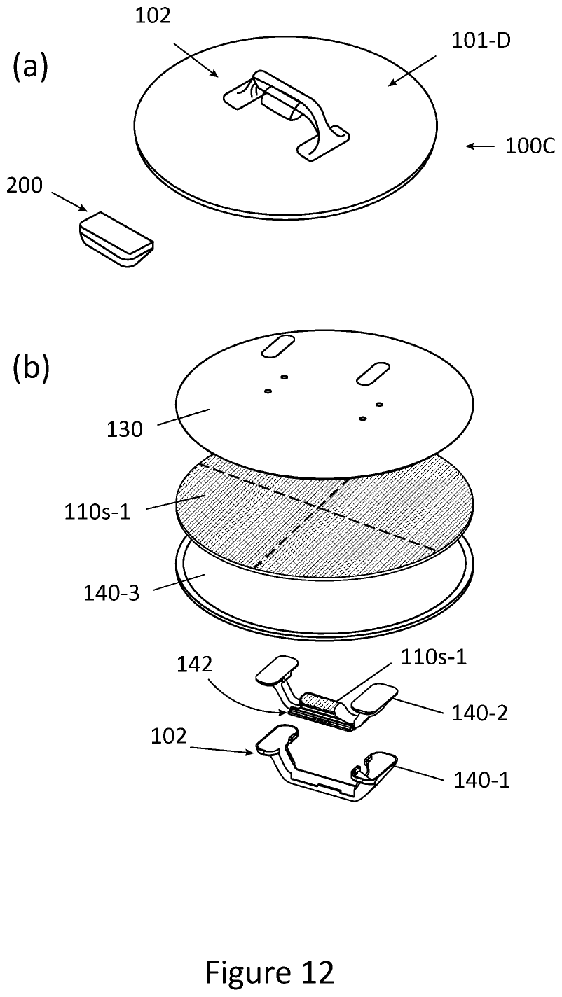

In the embodiment of FIG. 12(b), the peripheral device 100C is configured as a shield-like device with a shield portion 101-D and a handle portion 102. Similar to the sword 100B, the shield portion 101-C is a sensing element 101 for providing electrical signals to the main device 200 in response to proximity with a conductive object, e.g. through contact between the shield portion 101-C and a conductive object, which may be another peripheral device 100 such as the sword-like device 110C.

FIG. 12(b) shows an exploded view of the peripheral device 100C. The handle portion 102 comprises a rigid non-conductive housing 140 with a connector body portion 142 and a sliding rail mechanism for attaching to a main device 200. The housing 140 comprises at least two parts 140-1, 140-2 that fit together to support and retain the sensing electrodes 110. The shield portion 101-D operates as described with reference to FIG. 2(a). A non-conductive cover 130 is provided over the sensing portion 110s as an interface layer. The shield sensing portion 110s-1 can be formed of a substantially rigid or deformable material. The shield sensing portion 110s-1 connects to the main device 200 through contact with another sensing electrode 110 with a connector portion 110c (not shown). The shield portion 101-D can comprise multiple shield sensing portions 110s-1 distributed over the area of the shield portion 101-D, to provide spatially resolved touch/contact information. The shield sensing portion(s) 110s-1 can be supported by another portion 140-3 of the housing 140 as shown. Alternatively, the non-conductive cover 130 can be provided on both sides of the sensing portion 110s-1 (i.e. in the place of the housing portion 140-3 shown). The cover 130 may be formed of or comprise a fabric or a non-conductive thermo-formable material. For example, a fabric cover 130 can be formed over a substantially soft or deformable shield sensing electrode(s) 110 (e.g. formed of conductive EVA) by a heat press technique. Another sensing portion 110s-1 may also be provided in the housing 140 of the handle portion 102 as shown. This sensing electrode 110-1 can be exposed or isolated from the outside by a non-conductive material, e.g. the housing 140 or a cover 130 (not shown). Similar to in the sword-like device 100C, this sensing electrode 110-1 can be used as an additional sensing element for detecting when the handle portion 102 is being gripped or held by a user, e.g. operating as described with reference to FIG. 2(a). Alternatively, this sensing electrode 110-1 can be used as a ground plane 110gp. In another embodiment, the shield portion 101-D may further comprise a ground plane 110gp separated from the first sensing electrode by a non-conductive spacer 132 (not shown). The ground plane 110gp is located on the handle side of the shield portion 101-D to reduce potential interference caused by proximity of the user's hand to the shield sensing portion(s) 110s-1 when holding the handle portion 102.

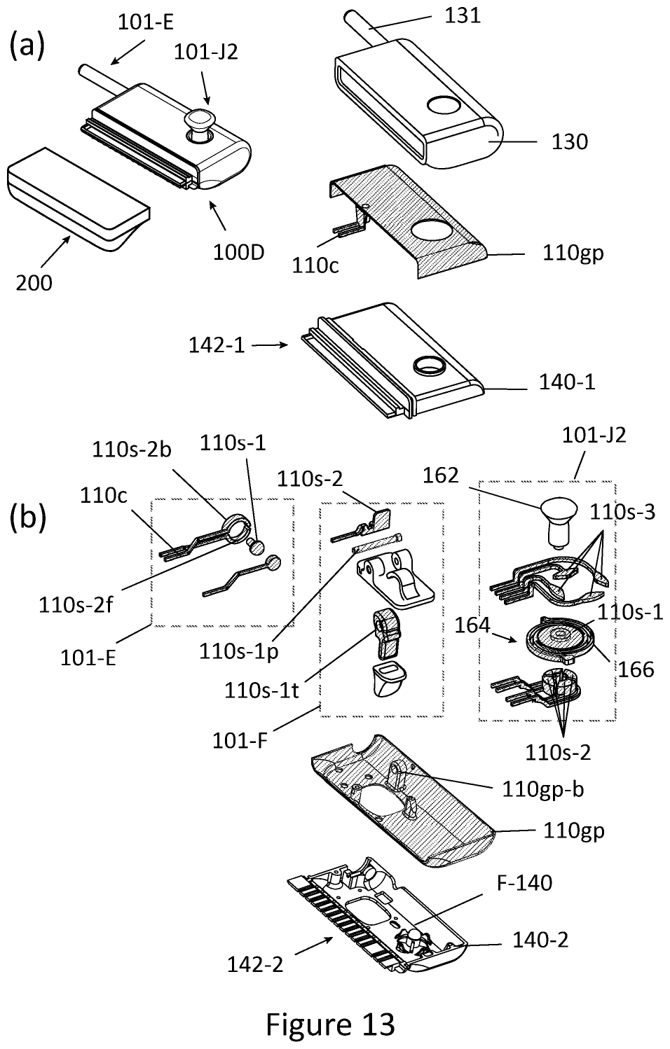

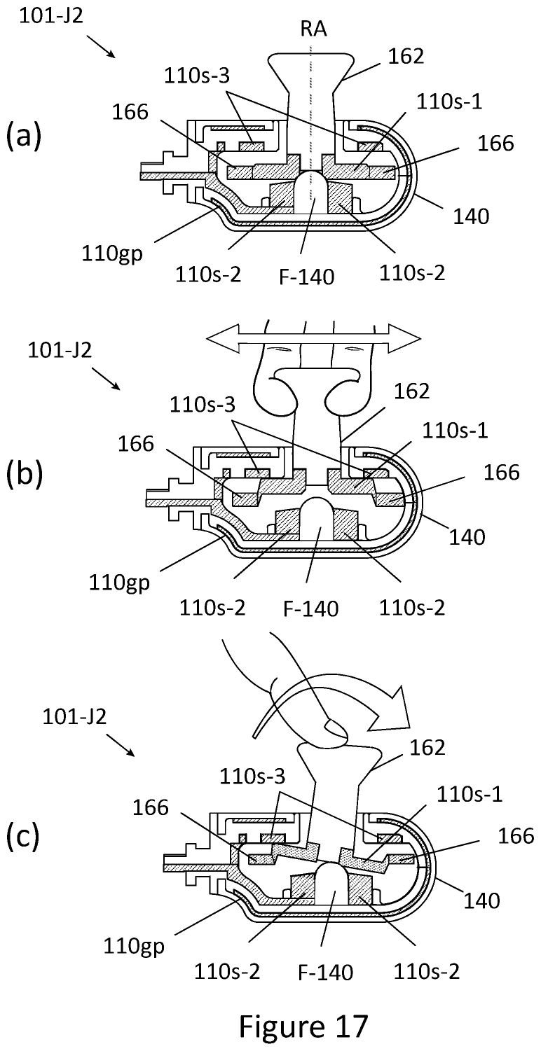

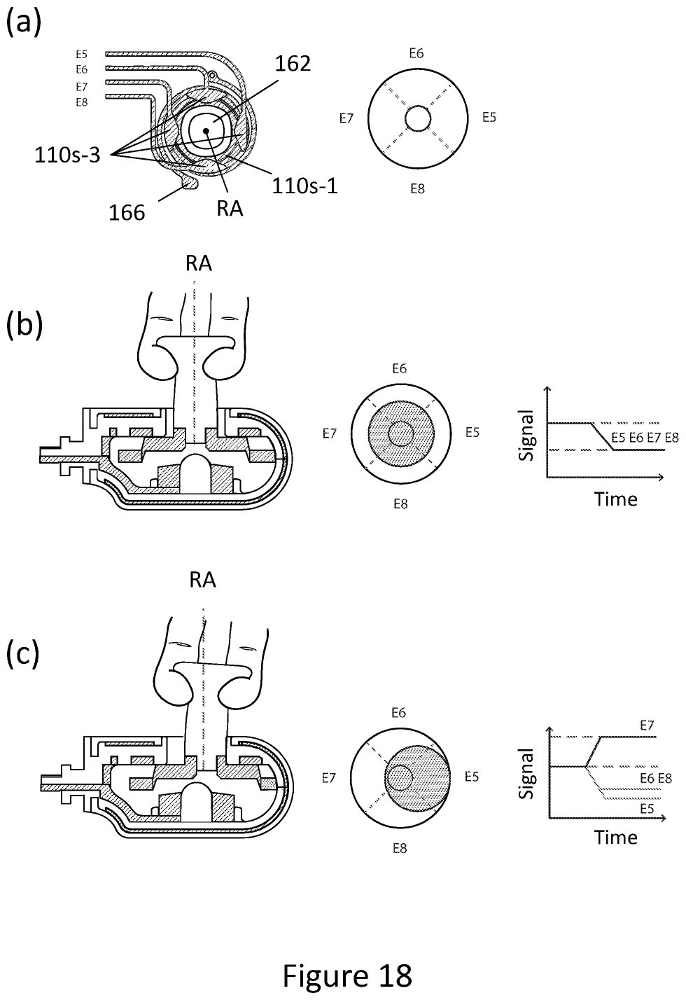

In the embodiment of FIG. 13(a), the peripheral device 100D has three sensing elements 101-E, 101-F, 101-J2 for providing electrical signals to the main device 200 in response to different user interactions. Sensing element 101-E is a sling shot, sensing element 101-G is a trigger and sensing element 101-J2 is a joystick. FIG. 13(b) shows an exploded view of the peripheral device 100D. The peripheral device 100D comprises a plurality of sensing electrodes 110, a rigid non-conductive housing 140 with a connector body portion 142 and a sliding rail mechanism for attaching to a main device 200, similar to device 100A. A cover 130 formed of substantially deformable non-conductive material is provided over the housing 140. Two of the sensing electrodes are configured as a ground plane 110gp for respective first and second parts 140-1, 140-2 of the housing 140. The sling shot 101-F and the trigger 101-G operates in a similar way to that described in FIG. 2(d). A force or pressure applied to the first sensing portion 110s-1 moves it relative to the second sensing portion 110s-2 and changes the capacitive interaction between them. In the case of the trigger 101-G, the first sensing portion 110s-1 is configured as a moveable trigger 110s-1t which is in contact with the ground plane 110gp through the pivot pin 110s-1p and integral pivot bracket 110gp-b. In the case of the sling shot 101-F, the first sensing portion 110s-1 is coupled to an elongate flexible member 131 of the cover 130 such that a force applied to the flexible member 131, such as a bending force, causes displacement of the first sensing portion 110s-1 relative to a pair of second sensing portion 110s-2f, 110s-2b. In this case, the first sensing electrode 110-1 is also connected to ground. The pair of second sensing portion 110s-2f, 110s-2b are configured as directional electrodes for detecting relative displacement of the first sensing electrode 110s-1 to the front (110s-2f) and back (110s-b). Operation of the joystick 101-J2 will be described in detail below with reference to FIGS. 17(a) to 18(c).

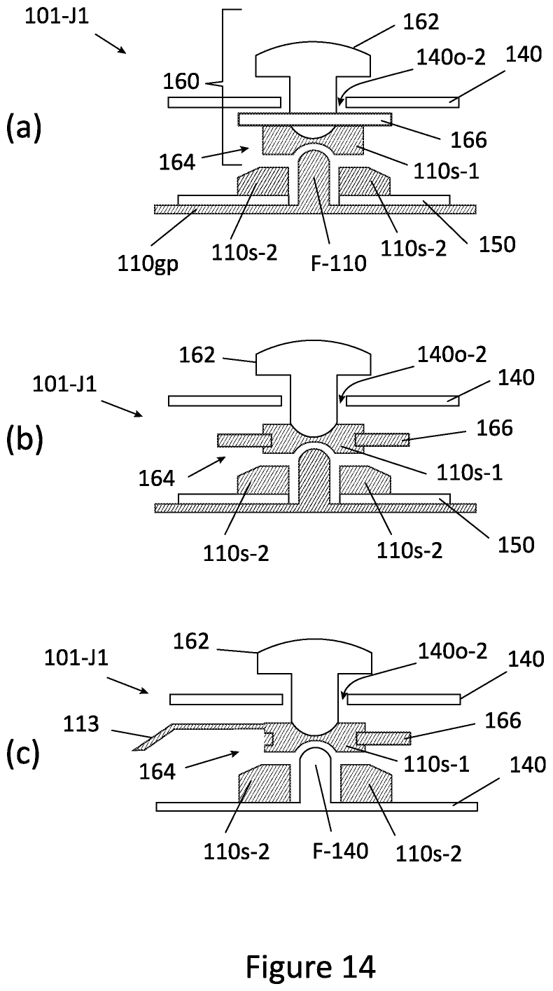

FIG. 14(a) shows a schematic cross-section of the joystick sensing element 101-J1 of the peripheral device 100A of FIGS. 4 and 5. The operating principle of the joystick 101-J1 is based on that described with reference to FIG. 2(d) in which first and second sensing portions 110s-1, 110s-2 are moveable relative to each other. The joystick 101-J1 comprises a movable actuator 160 with a non-conductive handle portion 162 that extends through an opening 140o-2 in the housing 140 and a base portion 164 located within the housing 140. The base portion 164 comprises a first sensing electrode 110 with a first sensing portion 110s-1 and is configured to pivot about a fulcrum F-110 to move the first sensing portion 110s-1 relative to a set of second sensing portions 110s-2 distributed about the fulcrum F-110 and positioned below the base portion 164/first sensing portion 110s-1. This changes the capacitance between the first sensing portion 110s-1 and the second sensing portions 110s-2 and provides one or more electrical signals for detecting a tilt direction and angle of the joystick 101-J1 with respect to the housing 140 or a rest axis RA of the actuator 160, as described below.

Each second sensing portion 110s-2 is associated with separate second sensing electrode 110-2. The fulcrum F-110 is integrally formed with the ground plane 110gp. The first sensing electrode 110-1 does not include a connector portion 110c and is configured to connect to the sensing circuit of the main device 200 through electrical contact with the fulcrum F-110. In this example, the first sensing electrode 110-1 rests and pivots directly on the fulcrum F-110. The joystick 101-J1 also comprises a resiliently deformable biasing element 166 coupled to the actuator 160 and configured to bias the actuator 160 towards the fulcrum F-110 and to a rest angular position (e.g. a central position) aligned with a rest axis RA when no force is applied to the actuator 160 and deform to permit movement (e.g. tilting) of the actuator 160 away from the rest position when a force is applied. The biasing element 166 is coupled to the movable actuator 160 at a radially inner end and is coupled to and/or engaged with the housing 140 or another stationary element of the device 100 at a radially outer end. As such, the radially outer end is fixed or stationary relative to the actuator 160. With reference to FIG. 5, the biasing element 166 is or comprises a spiral spring. However, it will be appreciated that the biasing element 166 can take other forms, e.g. a resiliently deformable disk-like member, or there may be a plurality of resiliently deformable biasing elements 166 coupled to and distributed about the actuator 160 (not shown). The biasing element(s) 166 can be formed of a non-conductive material as shown in FIG. 14(a), or a conductive material connected to or integrally formed with the first sensing electrode 110-1 as shown in FIG. 14(b).

FIG. 14(c) shows an alternative configuration of the joystick 101-J1 in which the fulcrum F-140 is integrally formed with the non-conductive housing 140. In this case, the first sensing electrode 110-1, and optionally the biasing element 166, is configured to electrically contact the ground plane 110gp at a different point, e.g. through a connector element 113, as shown. The connector element 113 may also serve to fix the radially outer end of the biasing element 166 relative to the actuator 160.

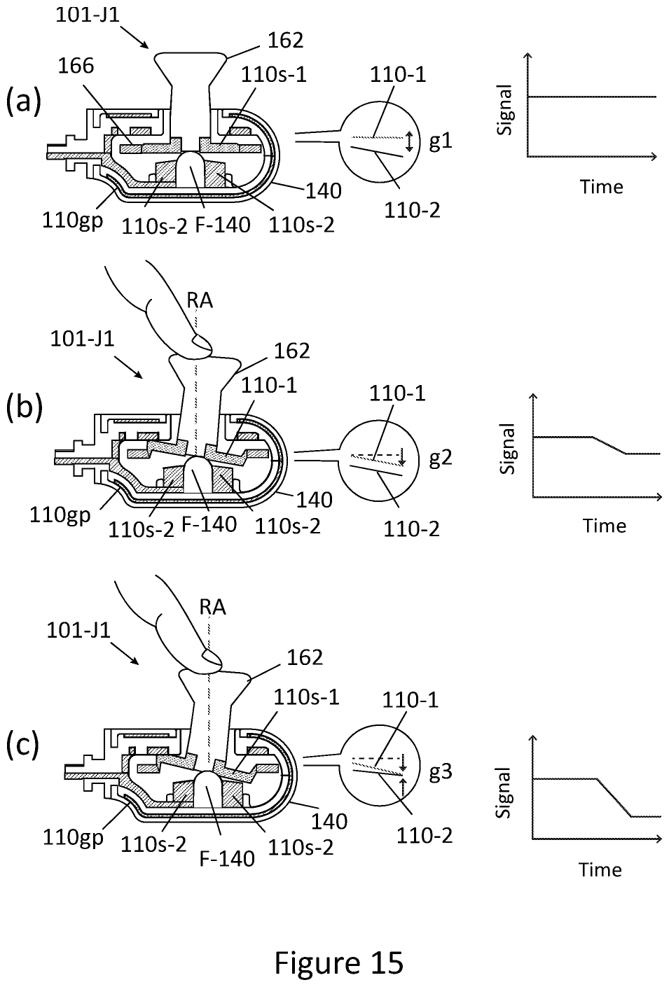

FIGS. 15(a) to 15(c) illustrate how the joystick 101-J1 operates in more detail. In this illustrated example the fulcrum F-140 is integrally formed with the housing 140 but the operating principle is the same for either a non-conductive or conductive, the only difference being how the first sensing electrode 110-1 is connected to ground plane 110gp. In operation, the capacitance between the first sensing electrode 110-1 and each of the second sensing electrodes 110-1, 110-2 of the joystick 101-J1 is measured by the capacitive sensing chip 230. When no force is applied to the handle portion 162, the actuator 160 is in the rest position and the first and second sensing portions 110s-1, 110s-2 are separated by a first distance g1, producing a baseline signal level measured between them as shown in FIG. 15(a). A lateral force applied to the handle portion 162 causes the actuator 160 to pivot about the fulcrum F-140 away from the rest axis RA in a given tilt direction. This reduces the separation between the first sensing portion 110s-1 and a second sensing portion 110s-2 to a second distance g2<g1 producing a change in the signal measured between them from the baseline level to an active level, as shown in FIG. 15(b). An active level may be defined by a suitable threshold change, as is known in the art. Further pivoting of the base portion 164 in the same direction further reduces the separation between the first sensing portion 110s-1 and the second sensing portion 110s-2 to a third distance g3<g2, producing a greater change in the signal measured between them, as shown in FIG. 15(c). In this way, a tilt angle relative to the rest axis RA of the actuator 160 can be determined based on the change in signals measured between the first and second sensing electrodes 110-1, 110-2 of the joystick 101-J1.

FIGS. 16(a) to 16(c) illustrate how a tilt direction can be determined from the signals measured between the first and second sensing electrodes 110-1, 110-2 of the joystick 101-J1. FIG. 16(a) shows the set of second sensing portions 110s-2 (in this example four) distributed equally about the fulcrum F-140 and rest axis RA and a corresponding polar map show how specific signals E1-E4 and pairs of signals measured from the second sensing electrodes 110-2 are associated with a tilt direction about the rest axis RA. By monitoring the change in signal from each second sensing electrode 110-2, the tilt direction can be determined, as described below. With reference to FIG. 16(b), when the handle portion 162 is tilted from the rest position in a direction aligned with one of the second sensing portions 110s-2 the signal measured from that sensing electrode, in this example E1, will change from its baseline level to an active level while the signal measured from an adjacent second sensing portion 110s-2, in this case E4, will exhibit a smaller or negligible change. Similarly, when the handle portion 162 is tilted in a direction oriented between two adjacent second sensing portions 110a-2 the signals measured at the respective sensing electrodes, e.g. signals E1 and E4, will both change from their baseline levels to substantially equal or similar active levels. FIG. 16(c) shows an example where the tilt direction is changed from aligning with one sensing portion 110s-2, as in FIG. 16(b), to two sensing portions 110s-2. In this case, the signals measured at the respective sensing electrodes, in this example signals E1 and E4, both change from their previous levels to substantially equal or similar active levels, as shown. In this way, the tilt direction can be determined based on the specific signals that change, and the tilt angle can be determined from the amount of change in those specific signal levels.

FIGS. 17(a)-17(c) show cross-sections of the joystick 101-J2 of the peripheral device 100D of FIGS. 13(a) and 13(b). The joystick 101-J2 is essentially the same as the joystick 101-J1 shown in FIG. 14(c) and described above, but additionally comprises a set of third sensing portions 110s-3 distributed about the fulcrum F-110/rest axis RA and positioned above the base portion 164/first sensing electrode 110. In this embodiment, the actuator 160 is moveable between a lower position in which the base portion 164 is pivotable about the fulcrum F-140 for detecting a tilt direction and angle of the joystick, as shown in FIG. 17(b), and an upper position in which the base portion 164 is translatable in one or more lateral directions with respect to the fulcrum F-140 and housing 140 as shown in FIG. 17(c).

As described above, the biasing element 166 is configured to bias the actuator 160 towards the fulcrum F-140 and a rest angular position, and thus also towards the lower position. In the lower position, the joystick 101-J2 operates as described above for the joystick 101-J1. Tilt angle and direction relative to the rest axis RA are determined from capacitance signals measured between the first sensing portion 110s-1 and the set of second sensing portions 110s-2. In the upper position, the actuator 160 is lifted away from the fulcrum F-140 and is free to move laterally. In the upper position UP, lateral movement of actuator 160 moves the first sensing portion 110s-1 relative to the set of third sensing portions 110s-3 and changes the capacitance between them. This enables lateral translation of the actuator 160 relative to the rest axis RA to be determined from capacitance signals measured between the first sensing portion 110s-1 and the set of third sensing portions 110s-3, as described below.

FIG. 18(a)-18(c) illustrate how a direction and amount of lateral translation of the actuator 160 can be determined from the signals measured between the first and third sensing electrodes 110-1, 110-3 of the joystick 101-J2. FIG. 18(a) shows the shows the set of third sensing portions 110s-3 (in this example four) distributed equally about the rest axis RA and a corresponding polar map show how the signals E5-E8 measured from the third sensing electrodes 110-3 are associated with a lateral direction about the rest axis RA. When no force is applied to the handle portion 162, the actuator is in the lower (rest) position and the capacitive interaction and signals measured between the first sensing electrode 110-1 and the set of third sensing electrodes 110-3 is at a baseline level. With reference to FIG. 18(b), when the handle portion 162 is lifted from the lower position to the upper position with no lateral translation, the signals measured from each third sensing electrode (E5-E8) will change from its baseline level to a substantially equal or similar active level. Once in the upper position, the signal levels measured at each third sensing electrode 110-3 are determined primarily by the spatial overlap of the third sensing portions 110s-3 with the first sensing portion 110s-1. The third sensing portions 110s-3 are shaped and configured to exhibit a change in overlap with lateral displacement from the rest axis RA. With reference to FIG. 18(c), when the handle portion 162 is then laterally translated away from the rest axis RA in a direction aligned with one of the third sensing portions 110s-3 the signal measured from that third sensing portion 110s-3, in this example E5, increases while the signal measured from an opposite third sensing portion 110s-3, in this case E7, decreases. Alternatively, the third electrode portions 110s-3 may be configured such that translation of the actuator 160 towards a given third electrode portion 110s-3 causes the signal measured from the opposite sensing portion 110s-3 to increase. Further translation in the same direction causes further disparity between the signals at the opposite third electrode portions 110s-3. In this way, the lateral translation direction can be determined based on the specific signals that change, and the amount of translation can be determined from the amount of change in those specific signal levels.

Although the specific embodiments of a peripheral device 100A, 100B, 100C, 100D shown in FIGS. 4-8(c) and 11(a)-13(b) include a sliding rail mechanism for releasably attaching to the main device 200, there are a number of alternative locking mechanisms suitable for this purpose which can be implemented. FIGS. 19(a) to 19(c) show alternative rail member 1421, 2421 configurations. FIGS. 20(a) and 20(b) show examples of plug and socket type locking mechanisms, in which the locking members 1421 of the peripheral device 100 are configured mechanically inter-engage with complementary locking members 2421 of the main device 200 through a force applied in a connection direction CD which is substantially perpendicular to the array of connector portions 110c. The locking members 1421 of the peripheral device 100 may be male locking members with a projection configured to engage with a recess of a female locking, or vice versa. Engagement may be via frictional engage or interference fit, and/or a snap-fit as shown in FIG. 20(b). In the configuration of FIG. 20(b), the locking members 1421 comprise projections configured to resiliently deform to snap into engagement with the recess of the other locking member 2421 upon application of a force in the connection direction CD, as is known in the art.

Alternatively, the locking mechanism can be based on magnetic engagement. In this case, the connector body portion 142 does not comprise locking members, but instead comprises magnets that interact with magnets of the opposite polarity on the main device 200 to releasably hold the two devices 100, 200 together in the connection position (not shown).

There are also a number of different ways to establish electrical connection between the non-metallic connector portions 110c of the peripheral device 100 and the electrical contacts 210 of the main device 200 suitable for mechanical and/or magnetic locking mechanisms. In the embodiment of FIG. 6, the electrical contacts 210 of the main device 200 are metallic spring fingers that contact an overlapping surface of the connector portion 110c. However, an electrical connection can also be made through contact with a distal end surface of the connector portions 110c. In addition, the electrical contacts 210 of the main device 200 can include a connection element 210c formed of non-metallic conductive thermo-formable material, similar to the connector portions 110c of the peripheral device 100, for establishing an electrical connection to the connector portions 110c. The connection element 210c may be provided on or over and/or extend from the metal contact 210.

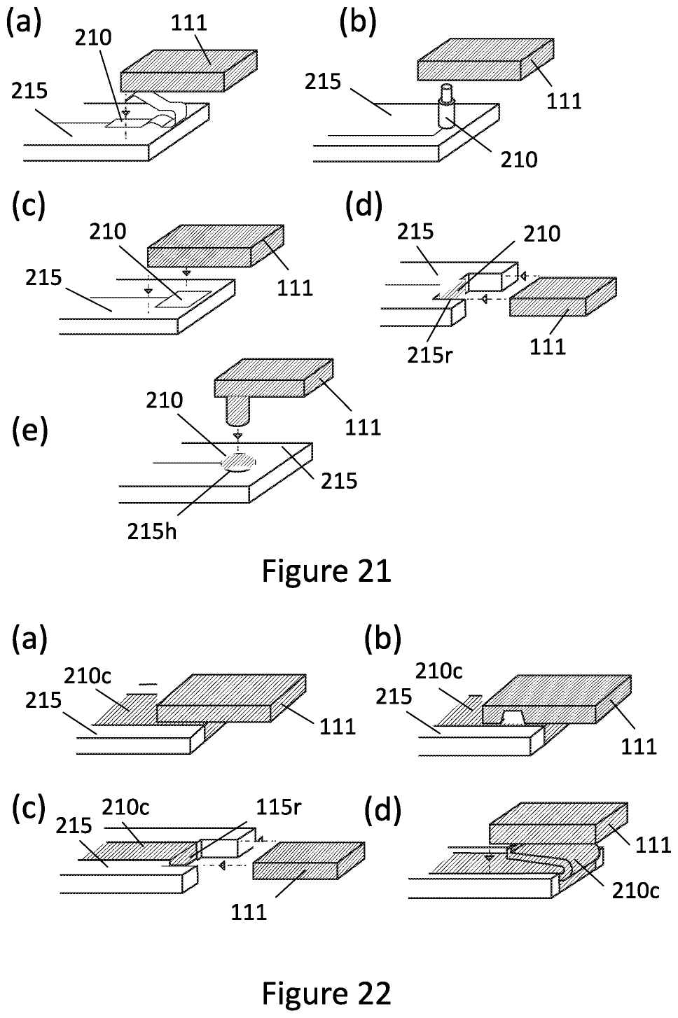

FIGS. 21(a) to 21(e) show different ways to establish an electrical connection between a metal electrical contact 210 of the main device 200 and a non-metallic connection portion 110c of the peripheral device 100. Each connector portion 110c comprises an exposed contact portion 111 configured to mechanically contact the electrical contact 210 of the main device 200. In FIGS. 21(a) and 21(b) the electrical contact 210 comprises a biasing element in the form of a metallic spring finger and pogo pin, respectively configured to bias against a surface of the contact portion 111 when the devices 100, 200 are connected. Biasing elements may help maintain a stable electrical connection. The spring finger may particularly well suited for use with a sliding rail mechanism, e.g. by orienting the spring finger in the connection direction CD. In FIG. 21(c) the electrical contact 210 is a simple metallic plate or pad for contacting an overlapping surface of the contact portion 111. In FIG. 21(d) the electrical contact 210 of the main device 200 is located on a peripheral edge of a circuit board 215 for contacting a distal end surface of the contact portion 111. The electrical contact 210 may be located in a recess 215r in the peripheral edge of the circuit board 215 for receiving the contact portion 111 as shown. Alternatively, in FIG. 21(e) the electrical contact 210 is located in a recess or through-hole 215h in the circuit board 215 for receiving a projection of the overlapping contact portion 111.

FIGS. 22(a) to 22(d) show different ways to establish an electrical connection between an electrical contact 210 with a non-metallic connection element 210c and the non-metallic connection portion 110c. In FIG. 22(a) the connection element 210c is a simple pad for contacting an overlapping surface of the contact portion 111. In FIG. 22(b) the contact portion 111 comprises a recess for receiving a corresponding projection of the overlapping connection element 210c. In FIG. 22(c) the connection element 210c is provided on a peripheral edge of a circuit board 210 for contacting an end surface of the contact portion 111. The connection element 210c may be located in a recess 215r in the peripheral edge of the circuit board 215 for receiving the contact portion 111 as shown. In FIG. 22(d) the connection element 210c comprises a biasing element in the form of a spring finger configured to resiliently deform to bias against an overlapping surface of the contact portion 111 when the devices 100, 200 are connected.

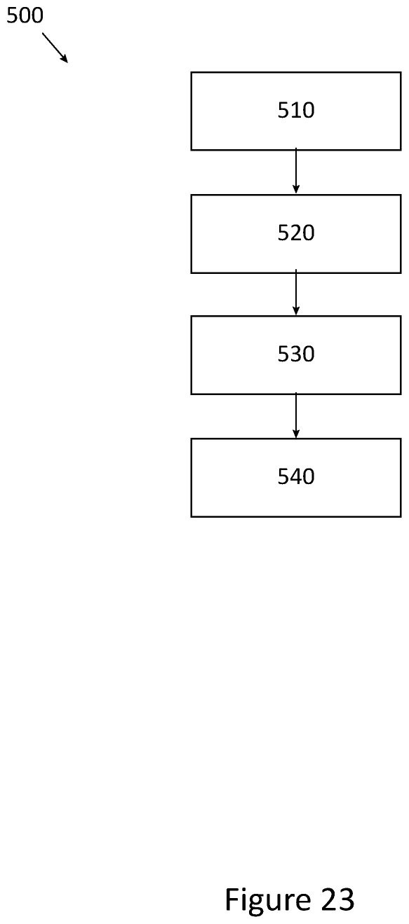

The conductive and non-conductive elements of the peripheral device 100 are formed from thermo-formable materials by one or more moulding processes such as injection moulding, compression moulding and, in some cases, over-moulding. FIG. 23 shows a method of manufacturing the peripheral device 100. In step 510, the plurality of sensing electrodes 110 are formed by a moulding process, such as injection moulding and/or compression moulding, depending in the specific material being used. The sensing electrodes can be formed from a substantially rigid or deformable thermo-formable material e.g. depending on the type of electrical contact. In step 520, the rigid housing 140 is formed from by a moulding process, such as injection moulding. In step 530, the soft/deformable cover 130 is formed by a moulding process, such as injection or compression moulding. In step 540, the conductive and non-conductive elements of the peripheral device 100 are assembled. The order of steps 510-530 can be interchanged.

Assembling the peripheral device 100 may comprise positioning one or more sensing electrodes 110 and ground planes 110gp at least partially within a first part 140-1 of the housing 140, and securing a second part 140-2 of the housing 140 to the first part 140-1 to retain the one or more sensing electrodes 110 in position. As a final step, a cover 130 may be applied on or over at least part of the rigid housing 140. Assembling the peripheral device 100 may comprise securing one or more sensing electrodes 110 to a part 140-1, 140-2 of the housing 140. The different part of the housing 140-1, 140-2 may be secured together by one or more fasteners such as screws or an adhesive. Assembling the peripheral device 100 may comprise assembling sub-parts of the various sensing elements 101, such as the trigger 101-F and/or joystick 101-J1, 101-J2 (e.g. handle portion 162, base portion 164, biasing element 166 of the actuator 160) before assembling with the housing 140.

The sensing electrodes 110, housing 140 and cover 130 can be moulded as separate elements which are then assembled together, or at least some of the elements can be moulded together. For example, the ground plane sensing electrode(s) 110gp and optionally one or more other sensing electrodes 110 can be moulded over or onto the interior of the rigid housing 140 in an over-moulding process, or vice versa. In addition, the soft cover 130 can be over-moulded onto the rigid housing 140. Further, non-conductive spacers layers 132 can be over-moulded onto a sensing electrode 110 or the ground plane 110gp. In embodiments where the cover 130 is a fabric and provided over a soft deformable sensing electrode 110, such as in devices 100B and 100C, the fabric cover 130 may be heat-pressed onto the sensing electrodes 110.

From reading the present disclosure, other variations and modifications will be apparent to the skilled person. Such variations and modifications may involve equivalent and other features which are already known in the art, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

For the sake of completeness it is also stated that the term “comprising” does not exclude other elements or steps, the term “a” or “an” does not exclude a plurality, and any reference signs in the claims shall not be construed as limiting the scope of the claims.

1-27. (canceled)

28. A peripheral input device module connectable to a main control device to form a coherent modular control device and provide one or more electrical signals to the main control device in response to a user interaction with the peripheral input device module, the input device comprising:
one or more sensing electrodes formed of a thermo-formable non-metallic conductive material, the or each sensing electrode configured to provide one or more electrical signals in response to a change in capacitance between:
(i) a sensing portion of the respective sensing electrode and a conductive object being near to or in contact with the respective sensing portion, and/or
(ii) a sensing portion of the respective sensing electrode and a sensing portion of another of the one or more sensing electrodes or another sensing portion of the respective sensing electrode;
wherein at least one of the one or more sensing electrodes comprises one or more connector portions that form an electrical connector, wherein each connector portion is configured to electrically connect to a respective electrical contact of a capacitive sensing circuit of the main control device for measuring the electrical signals.

29. The peripheral input device module of claim 28, wherein the peripheral input device module is formed entirely from thermo-formable materials; or wherein the peripheral input device module does not include any metal and/or electronic components.

30. The peripheral input device module claim 28, comprising a housing configured to support and retain the one or more sensing electrodes, wherein the housing comprises an integral connector body portion configured to hold the connector portions in place, and wherein the housing is formed of or comprises, at least in part, a substantially rigid thermo-formable material; and/or
wherein the connector portions of the one or more sensing electrodes are arranged in an array, and the connector body portion of the housing comprises one or more integral spacer elements that extend between adjacent connector portions to maintain a separation between them.

31. The peripheral input device module of claim 30, wherein the connector body portion of the housing further forms or comprises a locking mechanism configured to engage a locking mechanism of the main control device to releasably attach the peripheral input device module to the main control device, optionally or preferably, by mechanical engagement and/or magnetic attraction; and/or wherein the locking mechanism is or comprises a slide rail mechanism, and/or wherein the electrical connector and the connector body portion extend for a length along a side of peripheral input device module in a slide direction, and the connector body portion comprises one or more male or female rail members that extend at least part of the length of the connector body portion in the slide direction and are configured to slidingly engage one or more complementary rail members of the main control device.

32. The peripheral input device module of claim 30, comprising a cover provided on or over at least a portion of the housing, and wherein the cover is formed or comprises a substantially soft, flexible, deformable and/or pliable thermo-formable material.

33. The peripheral input device module of claim 28, wherein at least one of the one or more sensing electrodes is configured as a ground electrode comprising two or more connector portions, wherein at least one of the two or more connector portions is configured to connect to a ground contact of the sensing circuit of the main control device and at least one other of the two or more connector portions is configured to connect to a respective sense contact of the sensing circuit of the main control device, and wherein, when connected to the main control device, the ground electrode is configured to short the respective sense contact(s) to ground and provide a predefined electrical signal pattern or sequence at the electrical contacts of the sensing circuit of the main control device for identifying the peripheral input device module from other peripheral input device modules; and/or
wherein the connector portions of the one or more sensing electrodes are arranged in an array, and at least one other of the two or more connector portions of the ground electrode is arranged in a predefined position in the array to provide the predefined electrical signal pattern or sequence.

34. The peripheral input device module of claim 28, wherein each connector portion of the one or more sensing electrodes comprises an exposed contact portion configured to mechanically contact a corresponding electrical contact of the sensing circuit of the main control device to form an electrical connection between them; and optionally or preferably wherein the exposed contact portion is configured to abut, inter-engage with and/or bias against a corresponding electrical contact of the sensing circuit of the main control device, optionally or preferably, wherein the contact portion comprises one or more of: a projection, a recess, and a resiliently deformable biasing element.

35. The peripheral input device module of claim 28, wherein a sensing portion of at least one of the one or more sensing electrodes is separated from another sensing portion of the same or a different sensing electrode by a distance and is configured to move relative to the another sensing portion in response to an applied force or pressure, and wherein relative movement between said sensing portions causes the change in capacitance between them; and optionally or preferably
wherein a substantially deformable, flexible, and/or pliable thermo-formable non-conductive material is provided between the respective sensing portions; or the wherein respective sensing portions are separated by a gap.

36. The peripheral input device module of claim 35, wherein one of the respective sensing portions comprises a collapsible element configured to collapse and resiliently deform in response to an applied threshold force or pressure, and
wherein a first applied force or pressure below the threshold changes a separation between the respective sensing portions and provides a first change in the capacitance, and a second applied force or pressure at or above the threshold collapses the collapsible element and provides a second change in the capacitance and/or tactile feedback to the user; and, optionally or preferably, wherein proximity of a conductive object to at least one of the respective sensing electrodes causes a third change in capacitance; and, optionally or preferably
wherein the collapsible element is substantially dome-shaped; and/or wherein the respective sensing electrode with the collapsible element is configured to provide a ground plane when connected to the main control device.

37. The peripheral input device module of claim 30, wherein the housing comprises one or more openings, and wherein:
(i) a sensing portion of at least one of the one or more sensing electrodes extends at least partially into or through at least one of the one or more openings for receiving a user interaction; and/or
(ii) the peripheral input device module comprises a movable actuator that extends through one of the one or more openings to a sensing portion of at least one of the one or more sensing electrodes, the actuator configured to receive a user interaction and to transmit the user interaction to the respective sensing portion, and wherein the actuator is formed of or comprises one or more thermo-formable materials.

38. The peripheral input device module of claim 37, wherein the movable actuator comprises a joystick with a handle portion that extends through the one of the one or more openings and a base portion located within the housing,
wherein the base portion comprises a first sensing electrode and is configured to pivot about a fulcrum to move a sensing portion of the first sensing electrode relative to a set of second sensing portions distributed about the fulcrum, each second sensing portion being associated with a respective second sensing electrode with a connector portion;
wherein pivoting of the base portion causes a change in capacitance between the first sensing portion and the set of second sensing portions and provide one or more electrical signals for detecting a tilt direction and angle of the joystick with respect to the housing.

39. The peripheral input device module of claim 38, wherein the first sensing electrode is configured to electrically contact a fourth sensing electrode having a connector portion to connect to an electrical contact of the sensing circuit of the main control device; and wherein: the fulcrum is integral with the fourth sensing electrode, and the first sensing electrode is configured to electrically contact the fulcrum; or the fulcrum is formed of a non-conductive thermo-formable material, and is optionally integral with the housing; and optionally or preferably wherein the connector portion of the fourth sensing electrode is configured to connect to a ground contact of the sensing circuit of the main control device; and/or
wherein the joystick is moveable between a lower position in which the base portion is pivotable about the fulcrum for detecting a tilt direction and angle of the joystick, and an upper position in which the base portion is translatable in one or more lateral directions with respect to the fulcrum to move the sensing portion of the first sensing electrode relative to a set of third sensing portions distributed about the handle portion, each third sensing portion being associated with a respective third sensing electrode with a connector portion; wherein translation of the base portion causes change in capacitance between the first sensing portion and the set of third sensing portions and provides one or more electrical signals for detecting a translation of the joystick in one or more lateral directions with respect to the housing.

40. The peripheral input device module of claim 38, wherein the joystick further comprises a resiliently deformable biasing element configured to bias the joystick to a rest position and deform to permit movement of the joystick away from the rest position, the rest position includes the lower position; and/or wherein the resiliently deformable biasing element is formed of a non-metallic conductive thermo-formable material and optionally is integral with or coupled to the first sensing electrode; or wherein the resiliently deformable biasing element is formed of a non-conductive thermo-formable material; and optionally or preferably wherein the resiliently deformable element comprises a spiral spring or a disk-like member.

41. A modular control system, comprising:
a main control device; and
one or more peripheral input device modules, as defined in claim 28, configured to interchangeably connect to the main control device to form a coherent modular control device and provide one or more electrical signals to the main control device in response to a user interaction with a connected peripheral input device module,
wherein the main control device module comprises:
a capacitive sensing circuit configured to measure the one or more electrical signals provided by a connected peripheral input device module; and
an electrical connector comprising a plurality of electrical contacts of the capacitive sensing circuit, each electrical contact configured to electrically contact a respective connector portion of the connected peripheral input device module.

42. The modular control system of claim 41, wherein the electrical contacts of the capacitive sensing circuit are configured to mechanically contact an exposed contact portion of a respective connector portion to establish an electrical connection therebetween; and optionally or preferably
wherein each electrical contact of the capacitive sensing circuit is configured to abut, inter-engage with and/or bias against the exposed contact portion of the respective connector portion, and optionally or preferably, wherein each electrical contact of the capacitive sensing circuit and/or the contact portion of the respective connector portion comprises one or more of: a projection, a recess, and a biasing element.

43. The modular control system of claim 41, wherein each electrical contact of the capacitive sensing circuit comprises a metallic contact pad and/or a metallic mechanical biasing element such as a spring finger or pogo pin; or
wherein each electrical contact of the capacitive sensing circuit comprises a metallic contact and a connection element formed of a non-metallic conductive thermo-formable material provided over and/or extending from the metallic contact for contacting the connector portion, and optionally wherein the connection element comprises a contact pad and/or a mechanical biasing element.

44. The modular control system of claim 41, wherein the main device comprises a locking mechanism configured to engage a locking mechanism of the one or more peripheral input modules to releasably attach a peripheral input device module to the main control device, optionally or preferably, wherein the locking mechanisms of the main control device and the one or more peripheral input device modules are or comprise a sliding rail mechanism; and/or
wherein the main control device is configured to: determine one or more user interactions with the connected peripheral input device module based on measurement data from capacitive sensing circuit; and optionally or preferably: determine a unique identifier of the connected peripheral input device module based on detection of a predefined electrical signal pattern or sequence at the electrical contacts upon connection of the peripheral input device module to the main controller device; and/or communicate with an external computing device for controlling one or more operations of the computing device based on the determined one or more user interactions.

45. The modular control system of claim 41, wherein the modular control system comprises an external computing device in communication with the main control device, and the external computing device is configured to: execute one or more operations based on the one or more user interactions with the connected peripheral input device module determined by the main control device; and/or determine one or more user interactions with the connected peripheral input device module based on measurement data received from the main control device; and optionally or preferably determine a unique identifier of the connected peripheral input device module based on detection of a predefined electrical signal pattern or sequence at the electrical contacts upon connection of the peripheral input device module to the main controller device; and/or
wherein the main control device is or forms at least part of: a game console, a control system for a vehicle interior, or a computer peripheral.

46. A method of manufacturing the peripheral input device module as defined in claim 28, the method comprising: forming the one or more sensing electrodes from a thermo-formable non-metallic conductive material; forming a housing with an integral connector body from a thermo-formable material; forming a cover from a substantially soft, flexible, deformable and/or pliable thermo-formable non-conductive material; and assembling the peripheral input device module.

47. The method of claim 46, wherein the one or more sensing electrodes, the housing, and the cover, are formed by a moulding process, and optionally or preferably, wherein the moulding process includes one or more: of injection moulding; compression moulding; and over-moulding.
